(19) United States
(12) Patent Application Publication
(10) Pub. No.: US 2005/0034156 A1
(43) Pub. Date: Feb. 10, 2005

(54) Data broadcast material transmission system for ground wave digital broadcasting

(76) Inventor: Yuichi Terui, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/813,935

(22) Filed: Mar. 30, 2004

(30) Foreign Application Priority Data
Aug. 8, 2003 (JP) 2003-206903

(51) Int. Cl. H04N 7/173; H04N 7/10; H04N 7/025; G06F 3/00; H04N 5/445; G06F 13/00

(52) U.S. Cl. 725/40; 725/32; 725/132; 715/500.1

(57) ABSTRACT

In a data broadcast material transmission system for ground wave digital broadcasting which cannot be achieved without simultaneously transmitting to many locations (places) nationwide via a cable communications network of a communication provider, redundant information having a data carousel (rotating carousel) format used by a data broadcasting service for the ground wave digital broadcasting is eliminated and transferred to a digital broadcast material relay network serving as the cable communications network to be simultaneously broadcasted, and on each receiving side, the original data carousel is restored.

### BACKGROUND OF THE INVENTION

The present invention relates to a data broadcast material transmission system for ground wave digital broadcasting.

At present, preparations are progressing to start service of ground wave digital broadcasting. In CS digital broadcasting and BS digital broadcasting, which are forerunners thereof, facilities for uplinking to a satellite are not placed at multiple locations. Rather, a broadcasting station acting as a key has only to transmit broadcast materials (images, audio, data materials) to one location. In contrast, in ground wave digital broadcasting being introduced and encouraged now, many transmission stations (transmission towers) which are already built for performing the current analog broadcasts are scattered in great numbers throughout the entire country. In order to realize a nationwide broadcast similar to a ground wave analog broadcast, the broadcasting station which is the key and is responsible for the broadcast (hereinafter, sometimes referred to simply as the key broadcasting station) must perform real-time transmission of the images, audio, and data materials simultaneously across the entire country.

In this way, in order for a broadcast provider to conduct the ground wave digital broadcast, the broadcast provider needs a method for creating a flexible network between the key broadcasting station and the regional (base) broadcasting stations when needed, in order to simultaneously transmit the images, audio, and data materials in real time. In order to satisfy this need, a communication provider attempts to provide a digital broadcast material relay service via the digital broadcast material relay service provision network, which is built with optical fiber transmission lines and an ATM (Asynchronous TransferMode) network, and the broadcast provider uses this broadcast material transmission service.

For the data broadcast, in order to develop an equally or more robust CS digital broadcast, BS digital broadcast, etc. even in the ground wave digital broadcast, plans are being made using techniques such as MPEG (Moving Picture Experts Group)-TS (Transport Stream), DSM-CC (Digital Storage Media Command and Control) determined by ISO/IEC13818-6 (MPEG System Layer DSM-CC Expansion Standard), Data Carousel (Rotating Carousel) Transmission Method, BML, and B-XML.

Here, the data carousel transmission method is a content transmission method used in data downloading and in multi-media services, and is based on the ISO/IEC13818-6 DSM-CC data carousel specs, which are determined by ARIB STD-B24 (a standard for a data broadcast encoding format and transmission method used in digital broadcasts determined by the Association of Radio Industries and Businesses). According to this data carousel transmission method, download module information called DII (DownloadInformationIndication) and the download module called DDB (DownloadDataBlock) itself are repeatedly transmitted in a structure called a DSM-CC section.

Further, the BML (Broadcast Markup Language) determined by ARIB STD-B24 is the XML (Extensible Markup Language) application language, and only the tags and attributes which are used for multi-media expression are defined. The B-XML (Broadcast XML), which is determined by ARIB STD-B24, is a form of XML, and it represents the following. Namely, the XML tags defined for each application are respectively defined by a DTD (Document Type Definition) for each application, and when these are shown to a terminal, they are converted into BML tags by means of XSLT (Extensible Stylesheet Language Transformations). The DTD are XML text type declarations, and XSLT indicate specs for performing the text conversions.

When operating a data broadcasting service, in sections where radio waves are used to transmit between the transmission station (regional/base broadcasting stations) and receivers in the home of each subscriber, a technique is generally used which is called a carousel transmission method, which is a transmission method of repeatedly transmitting the same data. This technique is used with two expectations: capabilities of operation regardless the timing for turning on power and timing for switching channels on an end viewer/listener side, which is the receiver side; and effects of reduction in cost by reducing memory in devices on the receiving side.

Similarly, the Association of Radio Industries and Businesses has determined according to its standard that the same data is repeated by the data carousel transmission method determined in ISO/IEC13818-6 and ARIB STD B-24, and the broadcast is performed in multiplex form for the ground wave digital broadcast, too, as the ISO/IEC13818-6 standard (MPEG system layer standard) MPET-TS.

Conventionally, in the BS digital broadcast, content materials that were prepared at a location for preparing contents for the data broadcast are collected at the key broadcasting station, and multiple content materials are integrated to create a final program. Then, after carouselled and multiplexed, they are transmitted to the facility for uplinking to a satellite. In terms of integrating the program and in terms of group-managing the content materials, it is easy and rational to ultimately perform the transmission as radio waves, provided that the transmission is performed point-to-point not to multiple scattered locations but to a single location, as when transmitting to the satellite uplink facility.

However, in the ground wave digital broadcast, in addition to synchronizing the images, audio, data and other digital broadcast materials within the program to one other, it is also important to synchronize across multiple locations. Therefore, after integrating the image materials and the data broadcast data group in a manner that is easy to handle, it is extremely important to synchronize and simultaneously transmit them in real time to the regional broadcasting stations. The regional broadcast providers also have insufficient digital technicians and facilities. When performing the BS digital broadcast, one does not want to meaninglessly disperse to the regional areas the work, which requires specialized expertise, and digital expertise for synthesizing the final program and creating the data broadcast content, which require synchronization of the images, audio, data, and other materials within the program. When performing the ground wave digital broadcast, one wants to let the communication provider's broadcast material transmission service handle the synchronization across the multiple locations.

Therefore, assuming that applying the expertise developed in BS digital broadcasting is applied to ground wave digital broadcasting, the carouselling is performed according to the DSM-CC data carousel specs determined by ISO/IEC13818-6and ARIB STD-B24. After conversion to MPEG-TS according to the ISO/IEC13818-1 standard, a stream of data broadcast content that contains carousel redundant information must be sent in real time to multiple locations simultaneously.

Due to repeated broadcasting, there is redundancy contained in the stream which has been multiplexed according to the DSM-CC data carousel transmission method determined by ISO/IEC13818-6 and ARIB STD-B24 and by the ISO/IEC13818-6 standard MPEG-TS standard specs, and is then completed as the data broadcast program.

Therefore, when the ground wave digital broadcast service starts out, there will probably not be much communications volume (simultaneous transmission volume) of data broadcast content passing through the digital broadcast material relay service provision network (hereinafter, sometimes referred to as the digital broadcast material relay network), but it can be predicted that this will increase steadily with time and upon real diffusion and permeation. When this occurs, there is concern that the broadcast provider will be charged meaningless fees, and the communication provider's transmission bandwidth will be overpressured in the digital broadcast material relay network due to the carouselled data transmission.

### SUMMARY OF THE INVENTION

An object of the present invention is to provide a method enabling reduction of the meaningless fees for the broadcast provider and the pressure caused by the carouselled data transmission on the transmission bandwidth of the communication provider's digital broadcast material relay network, which is a cable communications network.

In order to solve the above-mentioned problems, in accordance with the present invention, a data broadcast material transmission system for ground wave digital broadcasting which cannot be achieved without simultaneously transmitting to many locations (places) nationwide via a cable communications network provided by a communication provider, eliminates redundant information having a data carousel (rotating carousel) format used by a data broadcasting service for the ground wave digital broadcasting, and transfers to a digital broadcast material relay network serving as the cable communications network to be simultaneously transmitted, and on each receiving side, the original data carousel is restored, to thereby achieve improvement of transmission efficiency (reduction of transmission costs) in the digital broadcast material relay network.

More specifically, a device having a function for parsing an MPEG-TS/eliminating carouselled redundant information is placed at the entrance portion to the digital broadcast material relay network, and the MPEG-TS is reconfigured with the carouselled redundant information eliminated and this is transferred over to the digital broadcast material relay network. After that, at each exit portion for transmission via the digital broadcast material relay network there is placed a device having a carouselled redundant information restoration (reconstruction) function for performing a reverse conversion.

According to a preferable embodiment mode of the present invention, there is provided a data broadcast material transmission method for ground wave digital broadcasting, which enables simultaneous transmission of images, audio, and data materials as broadcast materials to multiple locations via a cable communications network provided by a communication provider, the method including the steps of:
on a transmission side corresponding to an entrance portion to the cable communications network, eliminating, from an MPEG stream containing data broadcast materials, carousel redundant information set due to repeated transmissions; and
on a receiving side corresponding to an exit portion from the cable communications network, restoring the carousel redundant information to the MPEG stream.

The data broadcast material transmission method according to the present invention further includes the step of: setting a carousel redundant information elimination status into a user's free usage area in the MPEG stream, and transmitting it from the transmission side to the receiving side.

The carousel redundant information elimination status may include restoration timing and a restoration quantity.

Further, the user's free usage area in the MPEG stream may be a private section.

The data broadcast material transmission method according to the present invention further includes the step of: eliminating, as the carousel redundant information targeted for elimination, portions which are in 2^{nd} and subsequent cycles and have same version numbers as a DSM-CC section containing DII (DownloadInfoIndication) and a DSM-CC section containing DDB (DownloadDataBlock), and replacing these with private sections containing carousel skip descriptors having less information volume and indicating the carousel redundant information elimination status.

The data broadcast material transmission method according to the present invention further includes the step of: utilizing a time stamp in which a self-running counter counts upward based on a clock signal extracted from the MPEG stream on the input side, and constantly maintaining a program clock reference position of the post-processing MPEG stream on the output side at a predetermined interval of a fixed delay with respect to the MPEG stream on the input side.

In accordance with the present invention, in contrast to a case where transmission is performed by transferring files using FTP (File Transfer Protocol) for example, the broadcasting station (regional/base broadcasting stations) on the transmitted side only have to forward the received MPEG stream to a radio transmission facility. This inherits the convenience of the conventional techniques, in which the integration of the program and group management of the components of the data broadcast contents can be handled easily. Eliminating the redundant information in the data carousel transmission format reduces meaningless fees, and transmission bandwidth pressure on the cable communications network serving as the digital broadcast material relay network.

### BRIEF DESCRIPTION OF THE DRAWINGS

FIG. 1 is a block diagram showing a construction of a digital broadcast material transmission system according to an embodiment of the present invention;

FIG. 2 is a block diagram showing a detailed construction of the digital broadcast material transmitter (transmission-side device and reception-side device) of FIG. 1;

FIG. 3 is a diagram for explaining 3 types of DVB interfaces;

FIG. 4 is a diagram for explaining an overview of DVB-ASI specs;

FIG. 5 is a diagram showing processing blocks (both transmission side and reception side) of each DVB-ASI spec layer;

FIG. 6 is a diagram showing an example of MPEG-TS in the DVB-ASI bit stream;

FIG. 7 is a diagram for explaining pre-processing input MPEG-TS and post-processing output MPEG-TS of the transmission-side device;

FIG. 8 is a diagram for explaining pre-processing input MPEG-TS and post-processing output MPEG-TS of the reception-side device;

FIG. 9 is a diagram for explaining pre-processing input MPEG-TS and post-processing output MPEG-TS of the transmission-side device;

FIG. 10 is a diagram for explaining pre-processing input MPEG-TS and post-processing output MPEG-TS of the reception-side device;

FIG. 11 is a diagram showing constructions of carousel skip descriptors;

FIG. 12 is a diagram showing constructions of stuffing descriptors;

FIG. 13 is a diagram showing a construction of a private section (in a case where carousel skip descriptors are being transmitted);

FIG. 14 is a diagram showing a construction of a private section (in a case where stuffing descriptors are being transmitted);

FIG. 15 is a diagram showing a transport stream construction;

FIG. 16 is a diagram for explaining the private section;

FIG. 17 is a diagram for explaining the DSM-CC section (DII message transmission);

FIG. 18 is a diagram showing a data construction of the DII (DownloadInfoIndication);

FIG. 19 is a diagram showing a data construction of dmccMessageHeader( );

FIG. 20 is a diagram showing a transaction ID format;

FIG. 21 is a diagram for explaining the DSM-CC section (DDB message transmission);

FIG. 22 is a diagram showing a data construction of dsmccAdaptationHeader;

FIG. 23 is a flowchart for explaining DSM-CC data carousel redundancy elimination processing in the transmission-side device;

FIG. 24 is a flowchart for explaining DSM-CC data carousel restoration (reconstruction) in the reception-side device;

FIG. 25 is a block diagram showing a detailed construction of a TS extraction controller; and

FIG. 26 is a block diagram showing a detailed construction of a DVB-ASI generation control unit.

### DETAILED DESCRIPTION OF THE PREFERRED EMBODIMENTS

Next, explanation is given regarding embodiments of the present invention, with reference to the drawings.

[Data Broadcast Material Transmission System]

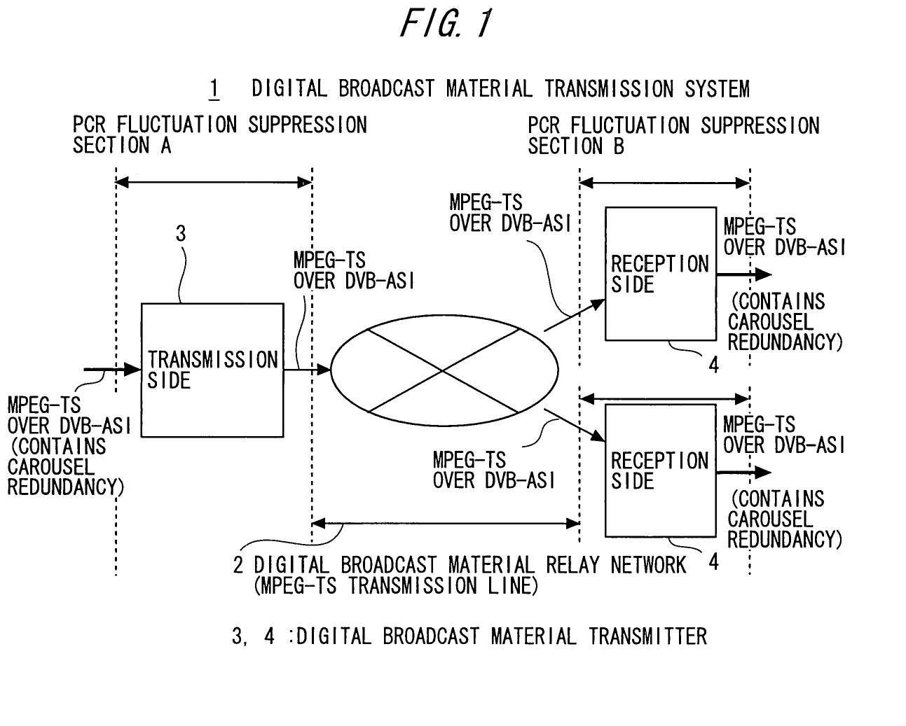

In FIG. 1, which shows a system configuration in accordance with an embodiment of the present invention, a digital broadcast material transmission system 1 includes a digital broadcast material relay service provision network (digital broadcast material relay network) 2, a digital broadcast material transmitter on a transmitting side (hereinafter, sometimes referred to simply as a transmission-side device) 3, and a plurality of digital broadcast material transmitters on a receiving side (hereinafter, sometimes referred to simply as reception-side devices) 4.

In the digital broadcast material transmission system 1, an asynchronous serial interface (DVB-ASI: Digital Video Broadcasting Asynchronous Serial Interface) is used as an interface between a broadcast provider and a communication provider. This DBV-ASI interface is an asynchronous serial interface developed by the European digital broadcasting standards organization DVB (Digital Video Broadcasting), and approved by ETSI (European Telecommunications Standards Institute).

The digital broadcast material relay network 2 is a relay service provision network for digital broadcast materials (images, audio, data materials) provided by the communication provider, and serves as an MPEG-TS signal transmission line. The digital broadcast material relay network 2 utilizes ATM (Asynchronous Transfer Mode) technology. Only valid MPEG-TS signals with data K28.5 (DVB-ASI standard 10-bit stuffing data) removed from the DVB-ASI signal are turned into ATM cells and forwarded (transmitted).

The digital broadcast material transmitters 3 and 4 are placed at an entrance to and an exit from the digital broadcast material relay network 2. Here, clear distinction is being made between the transmission-side device 3 and the reception-side device 4, but the same device may be constructed to have a sending function and a receiving function, allowing to achieve both the functions. The transmission-side device 3 is connected to a cable communications line of the key broadcasting station. The reception-side device 4 is connected to a cable communications line of the regional/base broadcasting station.

An MPEG-TS over DVB-ASI signal having redundancy due to the carousel (with carousel redundancy) is inputted into the transmission-side device 3 from an encoder which is omitted from the drawing, and the MPEG-TS over DVB-ASI signal with the redundancy removed (without carousel redundancy) is sent out to the digital broadcast material relay network 2. On the other hand, the MPEG-TS over DVB-ASI signal with the redundancy extracted is inputted into the reception-side device 4 from the digital broadcast material relay network 2, and the MPEG-TS over DVB-ASI signal with the restored carousel redundancy (reconstructed) is sent out (by wireless transmission) to a receiver at a subscriber's residence.

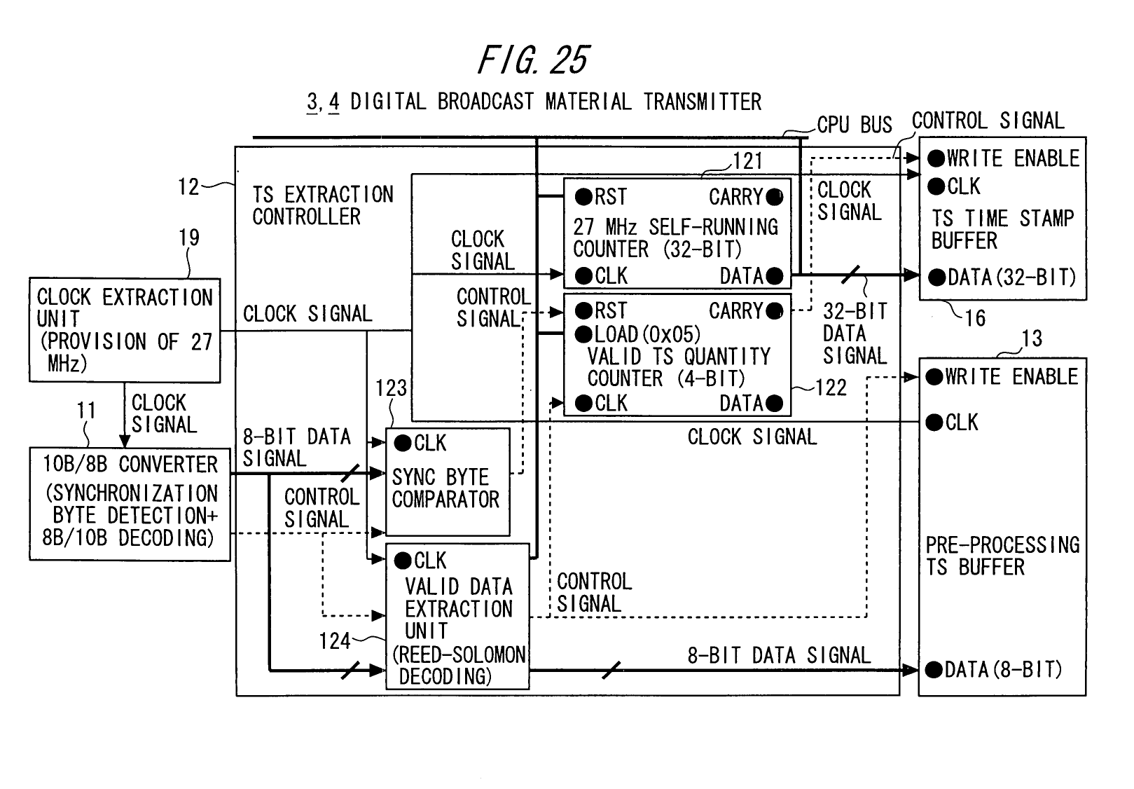

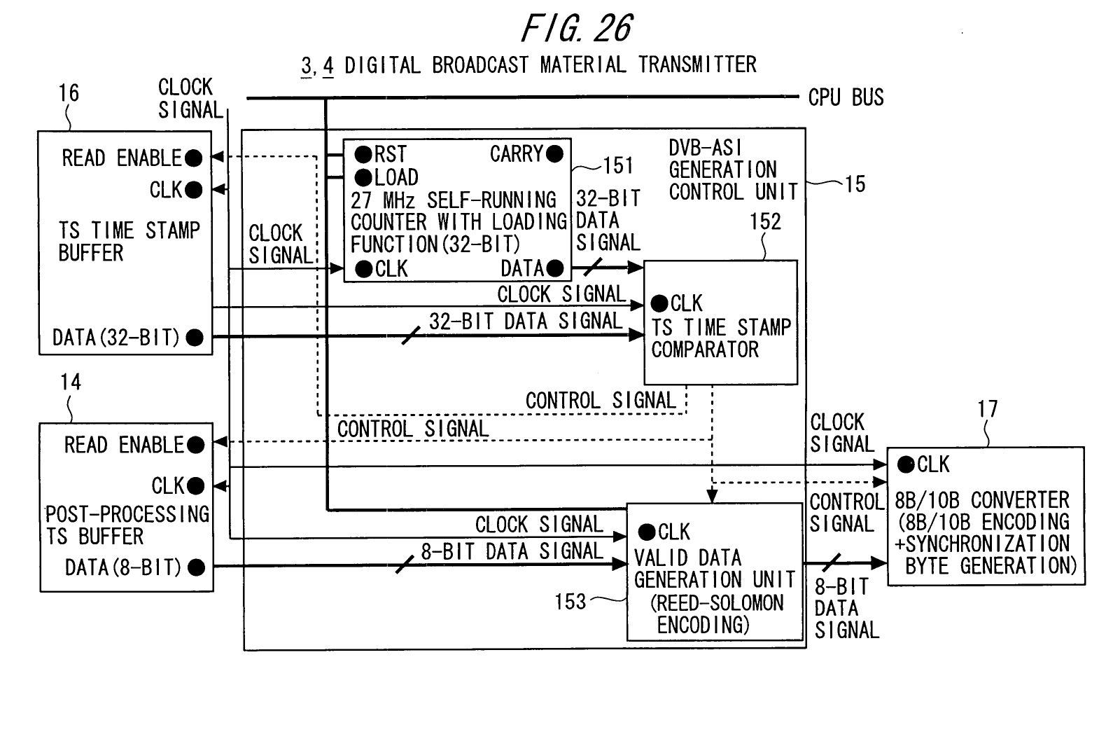

Note that, a PCR fluctuation suppression section A and a PCR fluctuation suppression section B indicate sections in the transmission-side device 3 and the reception-side device 4 where it is necessary to suppress PCR fluctuation with respect to a PCR (program clock reference) determined by ISO/IEC13818-1, which could affect an arrival time. Details are described below, with reference made to FIG. 25 and FIG. 26.

[Digital Broadcast Material Transmitter]

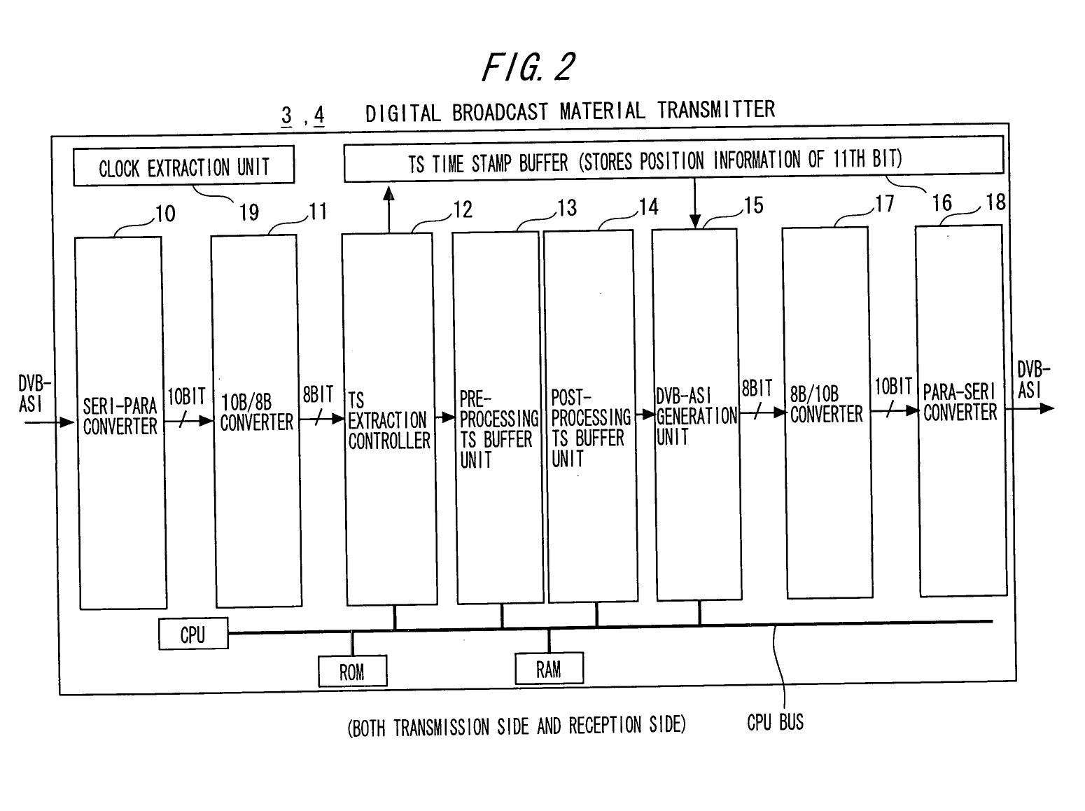

FIG. 2 shows the construction of the digital broadcast material transmitters shown in FIG. 1 (both the transmission-side device and the reception-side device) 3 and 4. Here is shown a construction for sending only, or for receiving only. However, the same device may be constructed to have the sending function and the receiving function, allowing both the functions to be achieved.

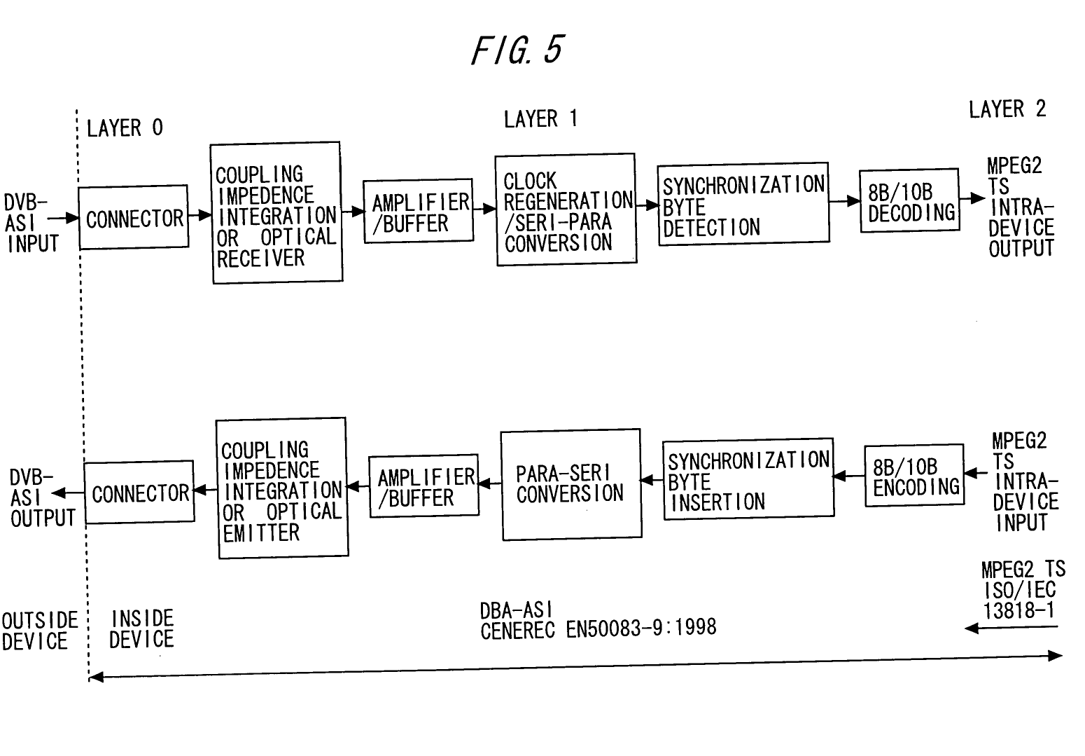

The DVB-ASI signal (strictly speaking, the MPEG-TS over DVB-ASI signal) which is inputted from the left is first converted into a 10-bit parallel signal by a seri-para (serial parallel) converter 10, and then converted into an 8-bit parallel signal by a 10B/8B converter 11. This 10B/8B converter 11 is a part, which performs both synchronized byte detection processing and 8B/10B decoding processing shown in FIG. 5 described below.

Next, a TS extraction controller 12 extracts only a valid TS (sometimes referred to as a transport stream packet or a transport packet) produced by eliminating stuffing data K28.5 patterns from the DVB-ASI signal. The extracted TS is aligned with Sync (Synchronization) bytes in the TS header so that a CPU (main control section) can handle it easily, and is written into a pre-processing TS buffer 13. At this time, a valid data position that is 10 bytes behind the TS Sync byte where the final PCR byte can appear, is written into a TS time stamp buffer 14 (storing positional information of an 11^{th} byte) by a time stamp expressing a 32-bit self-running counter value counting up at 27 MHz.

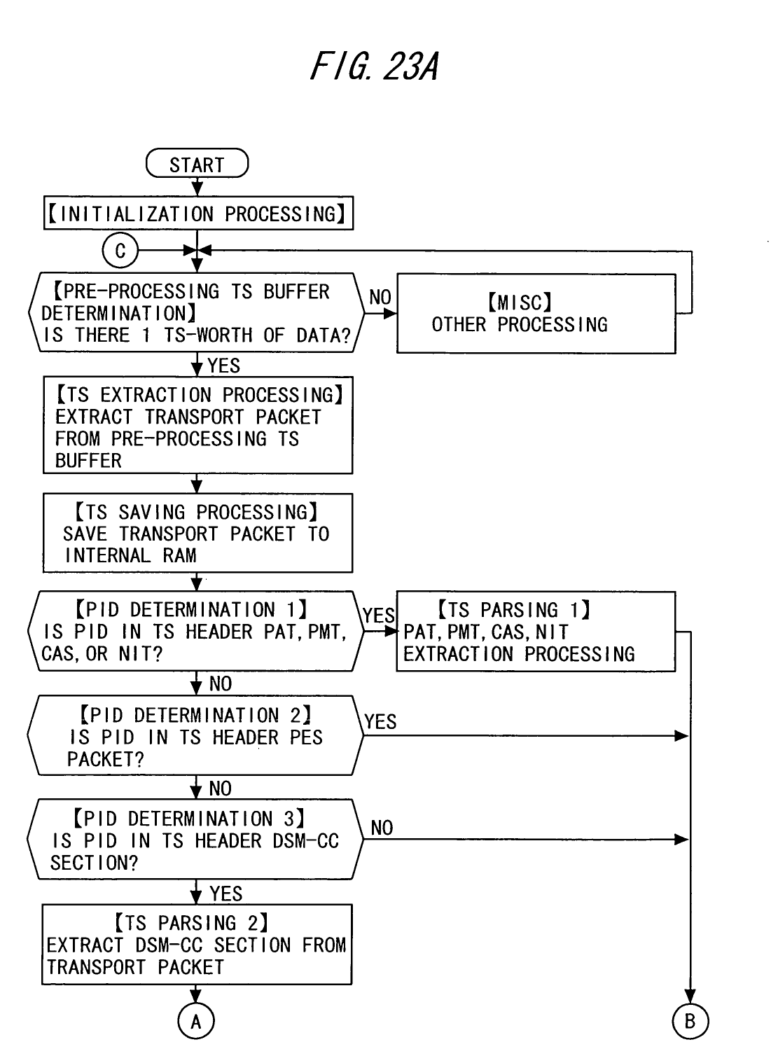

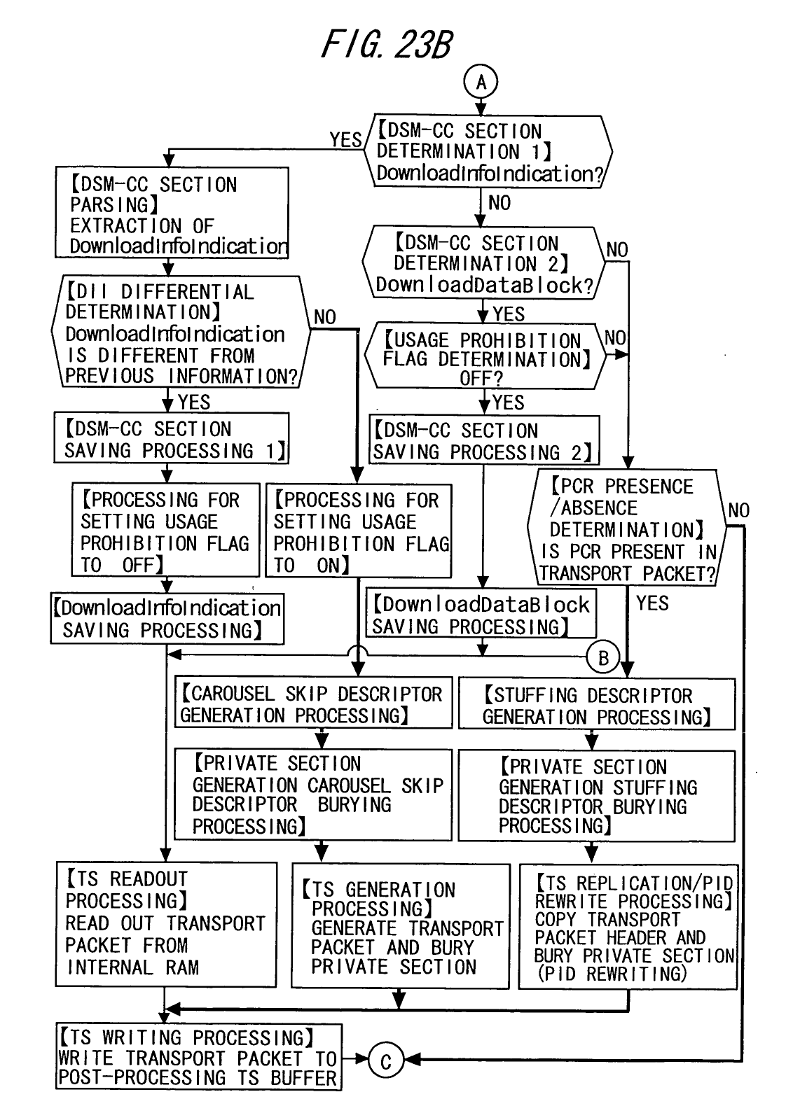

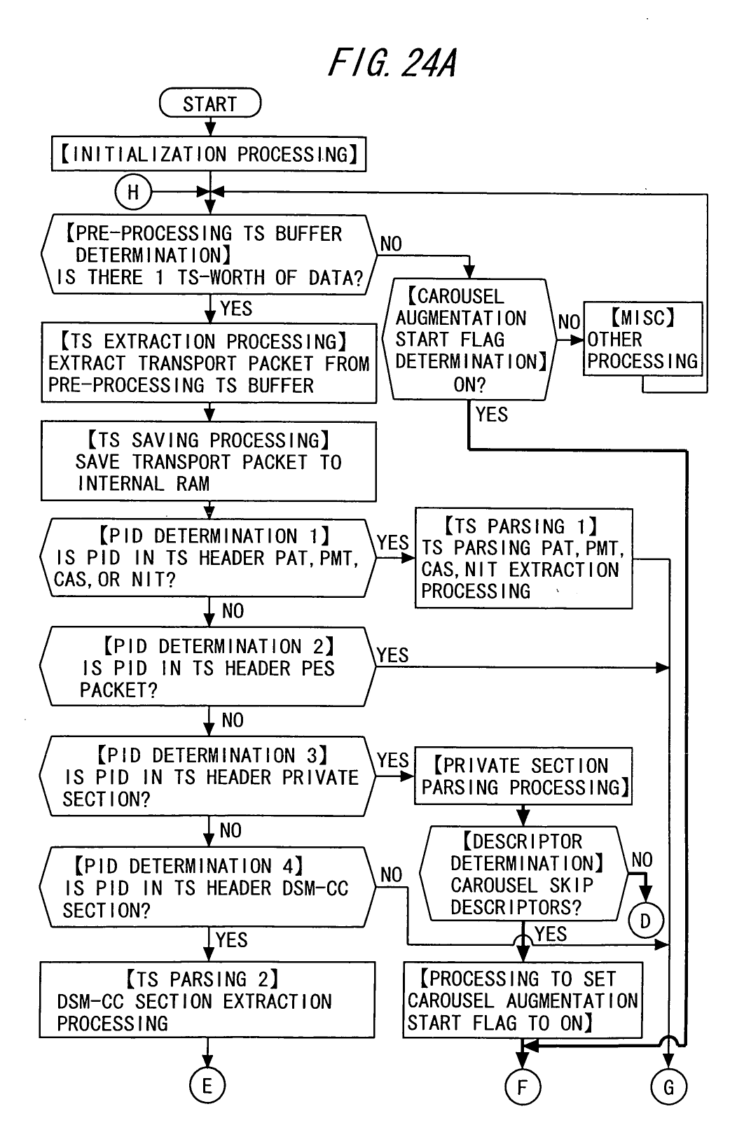

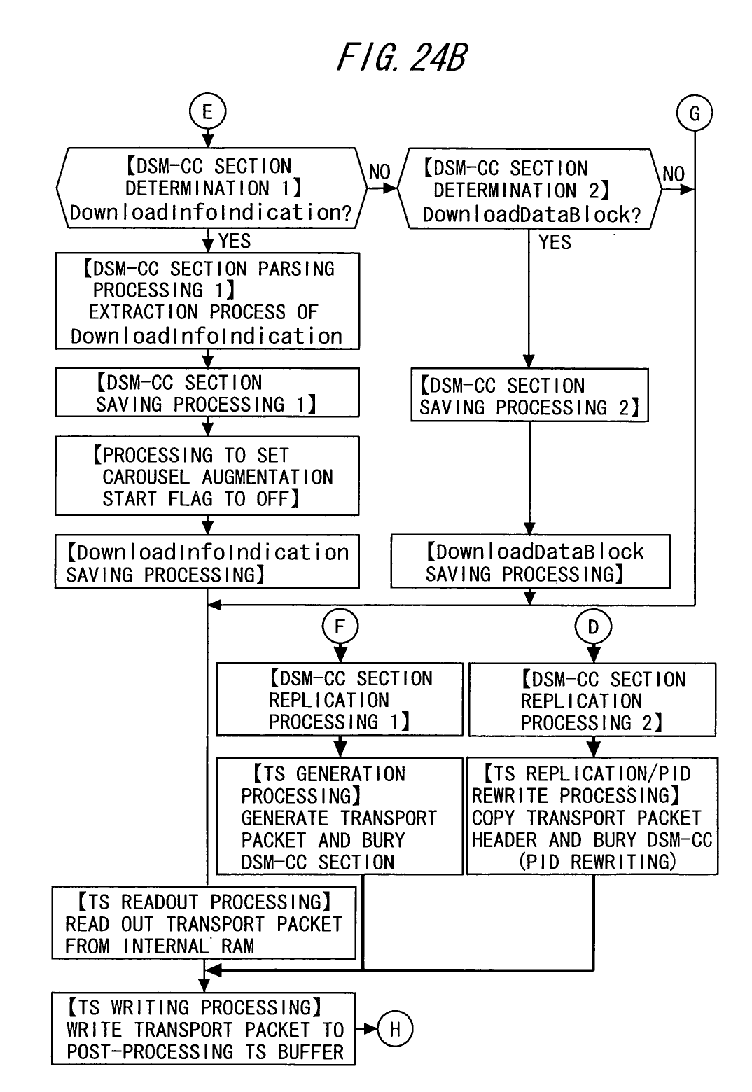

When the valid TS accumulates in the pre-processing TS buffer 13, the CPU reads out the TS from the pre-processing TS buffer 13 via a CPU bus, and, in accordance with processing sequences described below (FIG. 23, FIG. 24), eliminates the carousel redundancy in the case of the transmission-side device 3, or performs carousel restoration (reconstruction) with software processing in the case of the reception-side device 4, and after the latter processing, writes the processed data into the TS buffer 14.

A DVB-ASI generation control unit 15 fixes an intra-device delay according to an intra-device delay time setting which is set in advance by the CPU. In a case where a valid TS exists in the post-processing TS buffer 14, the valid TS is outputted (sent out) with the 11^{th} byte aligned with the positional information of a TS time stamp buffer 16 (storing the positional information of the 11^{th} byte). On the other hand, in a case where the TS does not exist, the stuffing data K28.5 determined by the DVB-ASI is outputted.

Next, the signal is converted from 8 bits to 10 bits by an 8B/10B converter 17, which performs both the 8B/10B encoding processing and synchronization byte insertion processing shown in FIG. 5 described below, which is further converted to a 270 Mbps serial signal by a para-seri (parallel serial) converter 18, and outputted to outside the device.

A clock extraction unit 19 is equivalent to a clock regeneration processing unit shown in FIG. 5 described below. An intra-device clock 27 MHz is generated from the input 270 Mbps serial signal, and is distributed to each portion. A ROM and a RAM serving as storage units are used by executing programs with processing sequences shown FIG. 23 and FIG. 24.

[DVB Interfaces]

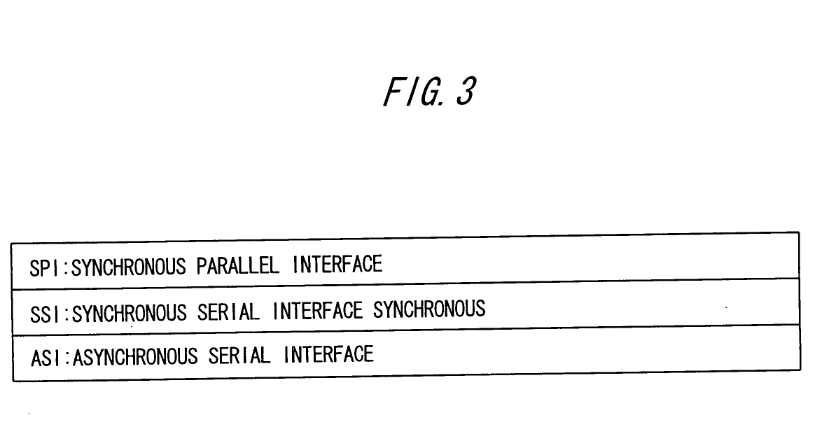

FIG. 3 shows 3 types of interfaces for digital broadcasting, which were developed by the European digital video broadcasting consortium DVB, and approved by ETSI (see ETSI standards documents).

Those 3 types of interfaces for DVB are:
(1) SPI: Synchronous Parallel Interface,
(2) SSI: Synchronous Serial Interface, and
(3) ASI: Asynchronous Serial Interface.
   [DVB-ASI Specs]

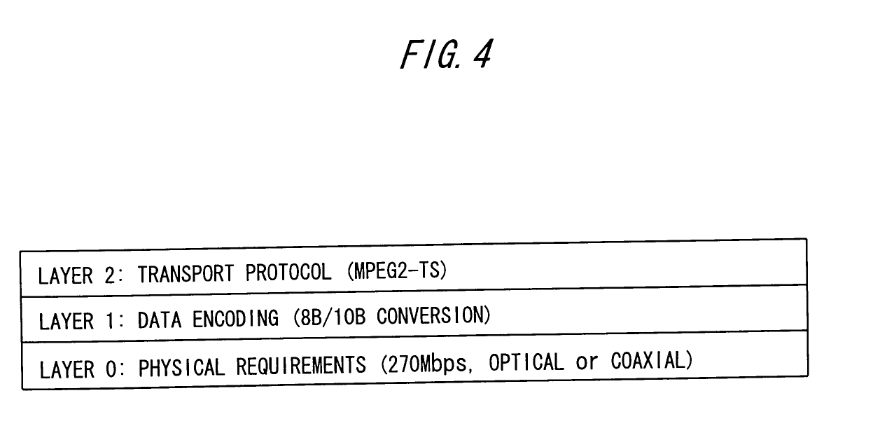

FIG. 4 shows a layer construction of a DVB-ASI (asynchronous serial interface). As shown here, in the DVB-ASI interface, the specs for transmitting the MPEG2-TS signal include 3 layers defined as Layer 0 (Physical Requirement), Layer 1 (Data Encoding), and Layer 2 (Transport Protocol) in which
Layer 0: physical specs (270 Mbps, optical or coaxial cable)
Layer 1: data encoding (8B/10B conversion), and
Layer 2: transmitting protocol (MPEG2-TS).

In other words, the physical specs are determined in layer 0, with optical cable or coaxial cable having a 270-Mbps transfer rate. In Layer 1, determination is made concerning data encoding for encoding 1 byte in 10 bits. In Layer 2, determination is made concerning the transfer protocol, according to which MPEG2-TS is transmitted.

FIG. 5 shows a basic processing block (both transmission-side and reception-side) of the DVB-ASI interface. As shown here, in Layer 1 (Data Encoding layer), provided on the upper DVB-ASI input side are clock regeneration, seri-para conversion, synchronization byte detection, and 8B/10B decoding; on the lower DVB-ASI output side are 8B/10B encoding, synchronization byte insertion, and para-seri conversion.

More specifically, in the upper Layer 0 and the lower Layer 0, the form of the connector is determined depending on the connector, and the electrical level is determined depending on a coupling impedance integration or an optical receiver (an optical emitter), and an amplifier/buffer.

In the upper Layer 1, the clock regeneration and the seri-para conversion determine the clock regeneration method and seri-para conversion method. The synchronization byte detection allows determination of the synchronization establishment method using the synchronization byte K28.5 stuffing data. The 8B/10B decoding allows determination of the data decoding method.

In the lower Layer 1, the 8B/10B encoding allows determination of the data encoding method. The synchronization byte insertion allows determination of the synchronization byte K28.5 stuffing data generation method. The para-seri conversion allows determination of the para-seri conversion method.

Note that, the parts which are determined here must be treated as being outside the scope of the present invention.

[Example of MPEG-TS Transmission by DVB-ASI]

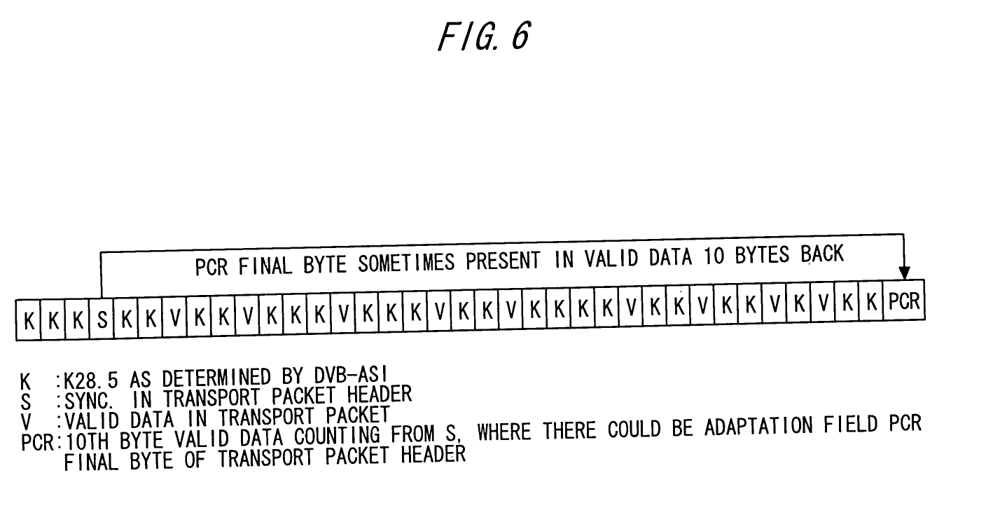

FIG. 6 shows an example of MPEG-TS transmission by DVB-ASI. That is, the DVB-ASI bit stream MPEG-TS transmission example is an example showing discretely derivable MPEG-TS valid data. As shown here, a valid transport packet (MPEG-TS) is transferred with the K28.5 stuffing data serving as the stuffing squeezed into a 270 Mbps fixed length which is determined by the DVB-ASI.

For purposes of convenience: the K28.5 stuffing data is represented by “K”; the transport packet header's Sync byte is represented by “S”; the valid data of the transport packet is represented by “Present”; and the valid data indicated by “Present” of the 10^{th} byte counting from the Sync byte “S” where the transport packet header's adaptation field PCR's final position could exist, is treated specially and is represented as a PCR (program clock reference). The configurations shown in FIG. 25 and FIG. 26 described below fixes the position, which is shown as the PCR for convenience, within the scope of responsibility of the present invention.

Note that, in the PCR shown here, the PCR fluctuation suppression section A and the PCR fluctuation suppression section B shown in FIG. 1 indicate positions of information whose fluctuations could influence an arrival time. Means for achieving this are discussed below referencing FIG. 25 and FIG. 26.

[MPEG-TS Construction]

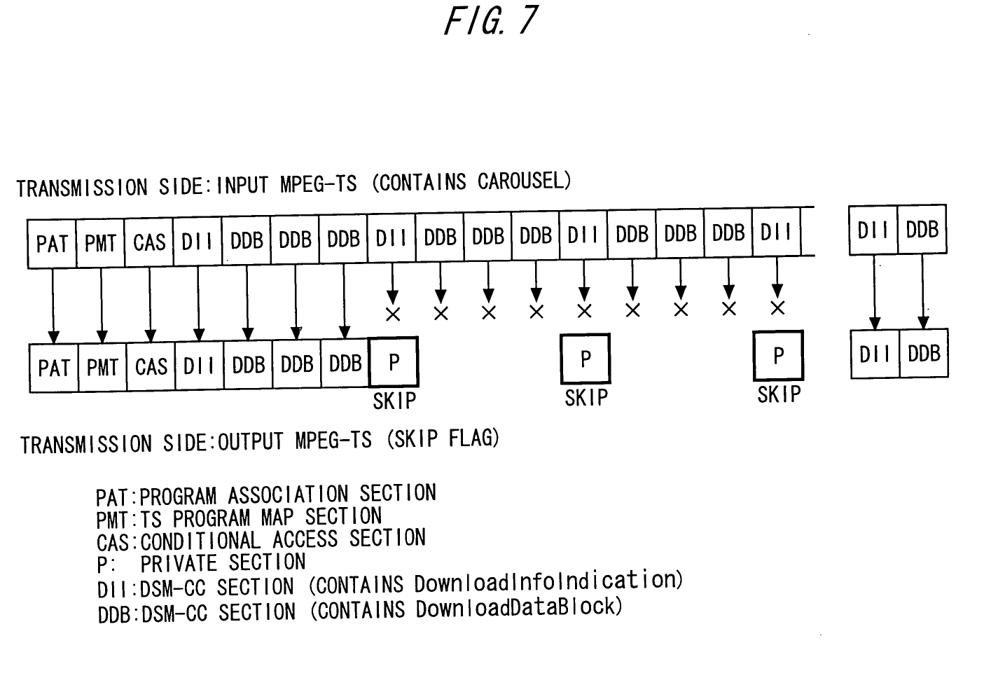

FIG. 7 shows TS-level carousel redundancy elimination from the MPEG-TS, in which the transmission-side device 3 pre-processing input MPEG-TS signal and post-processing output MPEG-TS signal contain no image or audio PES packets (i.e., a stream with no video or audio).

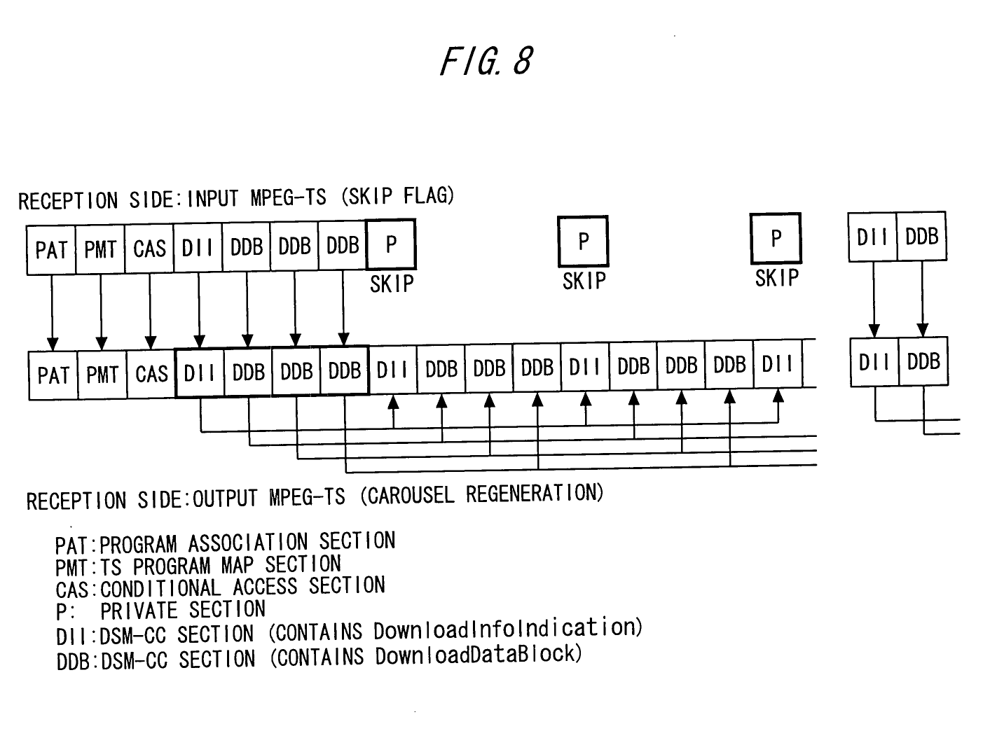

FIG. 8 shows TS-level carousel redundancy restoration (reconstruction) of the MPEG-TS, in which the reception-side device 4 pre-processing input MPEG-TS signal and post-processing output MPEG-TS signal contain no image or audio PES packets (i.e., a stream with no video or audio).

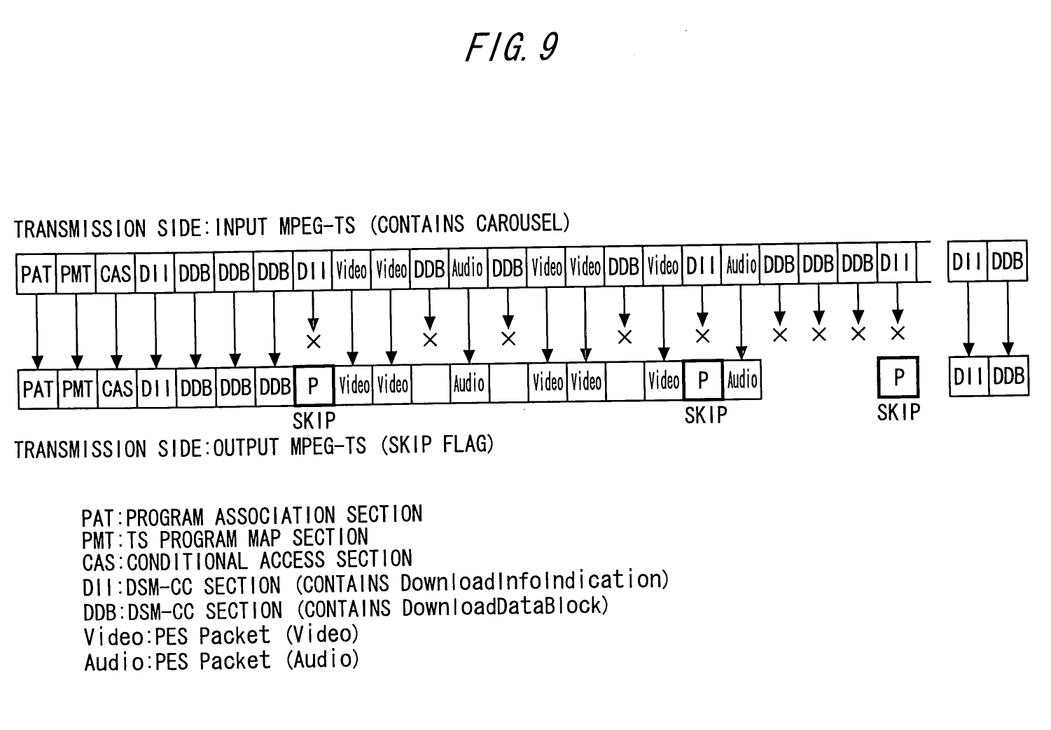

FIG. 9 shows TS-level carousel redundancy elimination from the MPEG-TS, in which the transmission-side device 3 pre-processing input MPEG-TS signal and post-processing output MPEG-TS signal contain image or audio PES packets (i.e., a stream with video or audio).

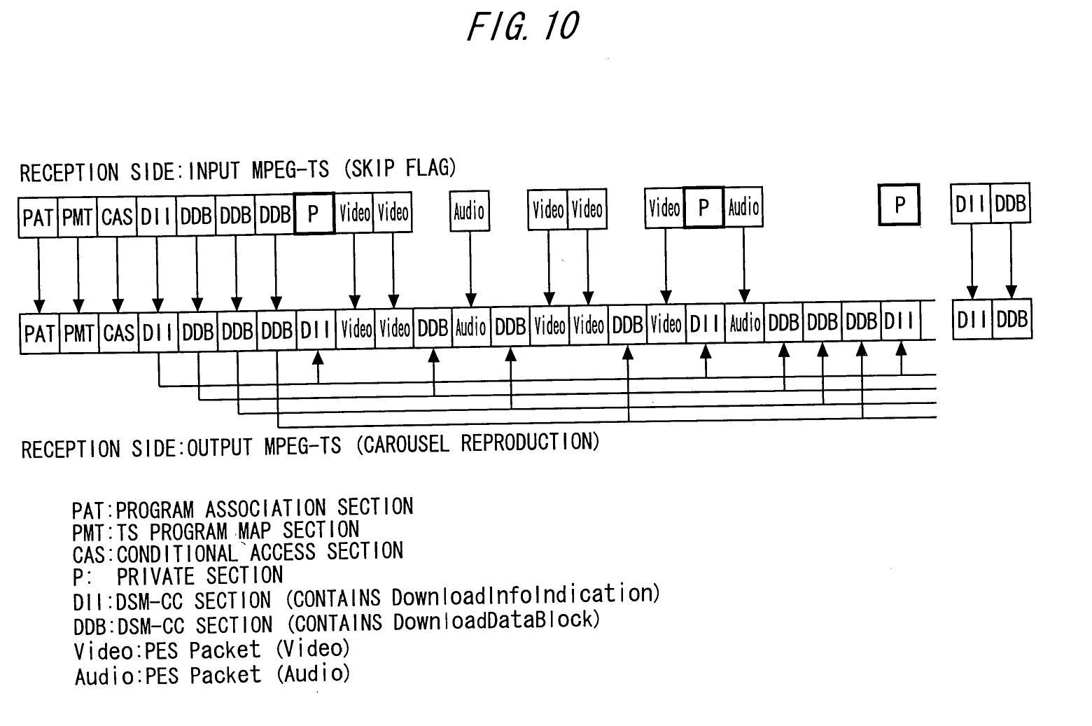

FIG. 10 shows TS-level carousel redundancy restoration (reconstruction) of the MPEG-TS, in which the reception-side device 4 pre-processing input MPEG-TS signal and post-processing output MPEG-TS signal contain image or audio PES packets (i.e., a stream with video or audio).

Here, the PES (packetized elementary stream) packets are data structures used to transfer elementary stream data, and are constituted of a packet header and many bytes of a subsequent elementary data stream. The PES packet is 1 layer of a system encoding syntax described in sections JT-H.222.0, 2.4.3.6.

FIG. 7 and FIG. 9 show an example of the input DVB-ASI signal (MPEG-TS signal) and the output DVB-ASI signal (MPEG-TS signal) in the transmission-side device 3 shown in FIG. 1. The diagrams show a private section indicated by reference symbol “P” being used to eliminate 2^{nd} (2^{nd} cycle) and subsequent DII (DownloadInfoIndication) and DDB (DownloadDataBlock) and replace them with the private section “P”, whereby the carouselled redundant information is eliminated.

FIG. 8 and FIG. 10 show an example of the input DVB-ASI signal (MPEG-TS signal) and the output DVB-ASI signal (MPEG-TS signal) in the reception-side device 4 shown in FIG. 1. The diagrams show the timing and quantity at the private section indicated by the reference symbol “P” being learned, and the second and subsequent DII and DBB carouselled redundant information being restored (reconstructed).

This private section P is a free usage area for the user, which can be used in the same packet layer as the DSM-CC section.

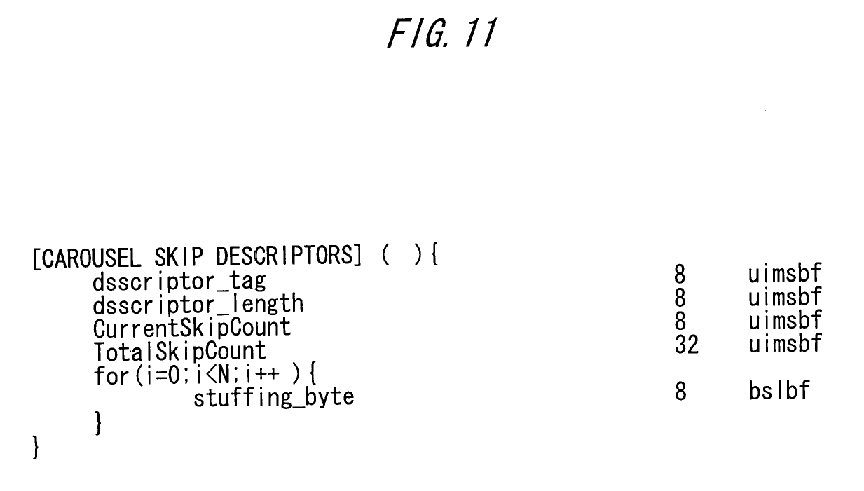

Here, PAT (Program Association Table), PMT (Program Map Table) and CAS (Conditional Access Table) are transport packets carrying PSI (Program Specific Information) determined by ISO/IEC13818-1. The private section P is with a transport packet, which uses a private section determined by ISO/IEC13818-1 to transfer descriptors indicated in the present invention in FIG. 11 through FIG. 14 described below.

The PSI is constructed of necessary normative data for demultiplexing of the transport stream and regenerating the program, and is described in JT-H.222.0, 2.4.4. One example of the PSI defined in the private is an unnecessary network information table.

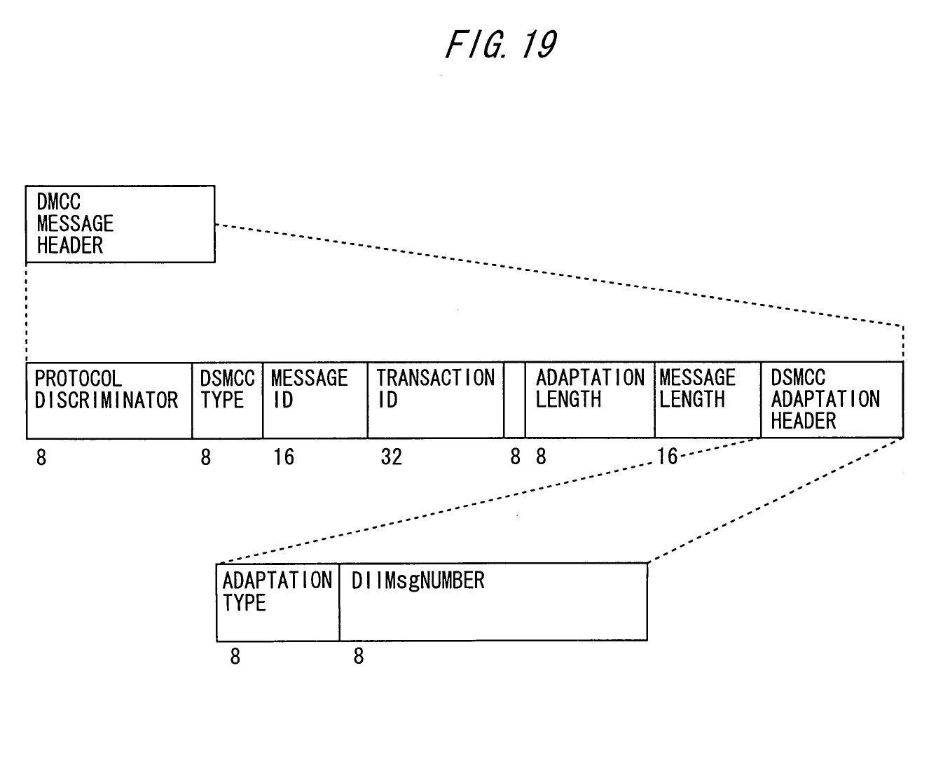

Further, the DII and DDB are transport packets which use a DSM-CC section determined by ISO/IEC13818-6, to carry the DII information and the DDB information determined by ARIB STD-B24. The DII stores various information regarding one or multiple download modules transferred as the subsequent Download Data Block information (for details, see FIG. 18 described below). The DBB is one or multiple download modules (for details, see FIG. 19 described below).

Furthermore, the video and audio are transport packets for carrying the images and audio by means of the PES determined by ISO/IEC13818-1.

More specifically, the PAT (Program Association Table) is 1 type of Program Specific Information (PSI) determined by ISO/IEC13818-1, and assigns a program number and a program map table PID (Packet Identifier). The PMT (Program Map Table) is 1 type of program specific information determined by ISO/IEC13818-1, and determines PID values of 1 or more program constitutive elements. The CAS (Conditional Access Table) is one type of program specific information determined by the ISO/IEC13818-1, and it assigns unique PIDs to 1 or more private EMMs (EntitlementManagementMessage). Here, the PID is a unique integer value used to link an elementary stream inside one program transport stream or multiple program transport streams, described in sections JT-H.222.0, 2.4.3.

Further, DII is downloadInfoIndication information transmitted by the DSM-CC section determined by ISO/IEC13818-6 and ARIB STD-24. DDB is downloadDataBlock information transmitted by the DSM-CC section determined by ISO/IEC13818-6 and ARIB STD-24. Video is an MPEG image signal transmitted as the PES packet. Audio is an MPEG audio signal transmitted as the PES packet.

[Carousel Skip Descriptors]

FIG. 11 shows descriptors defined by the present invention for transmitting information from the transmission-side device 3 to the reception-side device 4 indicating that the redundant information created by carousel has been removed at the transmission-side device 3. Here, a tag value showing a carousel skip descriptor is buried into descriptor_tag (8-bit). The descriptor's length is buried into descriptor_length (8-bit). An omitted DII and DDB skip quantity (i.e., when a range from and including one DII to the DDB before the next DII is treated as a single unit, the number of times this unit is omitted) is buried into CurrentSkipCount (32-bit). A total number of subsequent skips serving as a trigger is buried into TotalSkipCount (32-bit). The stuffing data is buried into stuffing_byte (8-bit).

The carousel skip descriptor is structured as a descriptor for transmitting the number of skip times of the carousel used as the content of the private section, which is sent from the transmission-side device 3 to the reception-side device 4 to show that the redundancy caused by the carousel has been removed in TS units in the transmission-side device 3. The reception-side device 4 thus knows that the discontinuities in the TS serial numbers have been filled in, and knows the timing of the carousel restoration (reconstruction).

[Stuffing Descriptors]

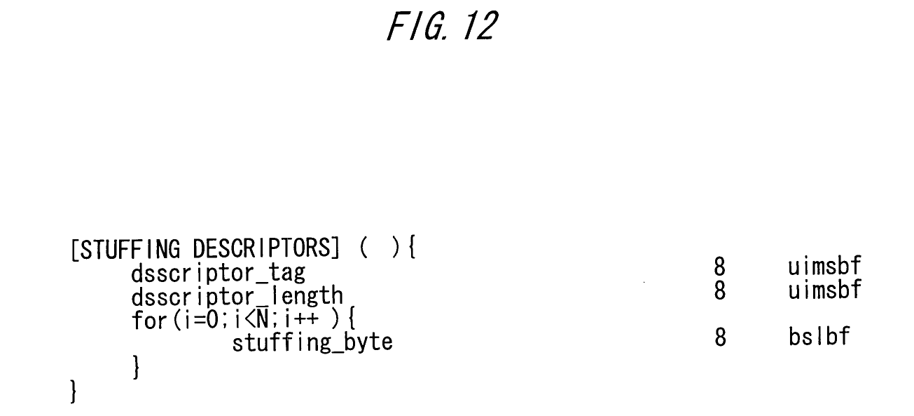

FIG. 12 shows stuffing descriptors defined in the present invention for informing about the stuffing for the PCR transmission purpose. A tag value indicating a stuffing descriptor is buried into descriptor_tag (8-bit). The length of the descriptor is buried into descriptor_length (8-bit). The stuffing data is buried into stuffing_byte.

The stuffing descriptor is structured as a descriptor for stuffing, which is used as the content of the private section that is sent from the transmission-side device 3 to the reception-side device 4, and is used in a case when a simple skip cannot be performed because PCR is in the TS header, at the time when the transmission-side device 3 tries to remove the carousel redundancy in TS units. The stuffing descriptor is a means for transmitting the PCR to the reception-side device 4.

[Private Section Structure]

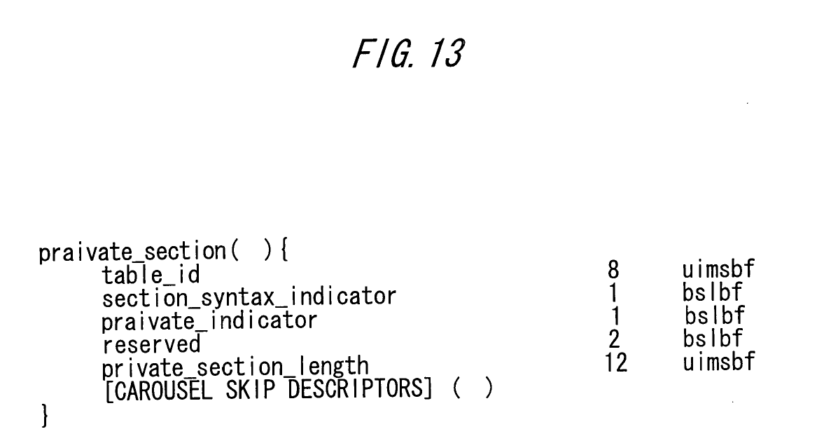

FIG. 13 shows the carousel skip descriptor buried into the private section determined by ISO/IEC13818-1, in the case where the carousel skip descriptor carousel is being transmitted. Here, an example using the private section has been given. There are also methods using a private data area in the DSM-CC section, and private data area in the PES packet.

A table identifier for transmitting the carousel skip descriptor is buried into table_id (8-bit). “0” is buried into section_syntax_indicator (1-bit). “1” is buried into private_indicator (1-bit). The number of bytes of the subsequent private_data_byte is buried into private_section_length (12-bit). The carousel skip descriptors shown in FIG. 11 are buried into private_data_byte.

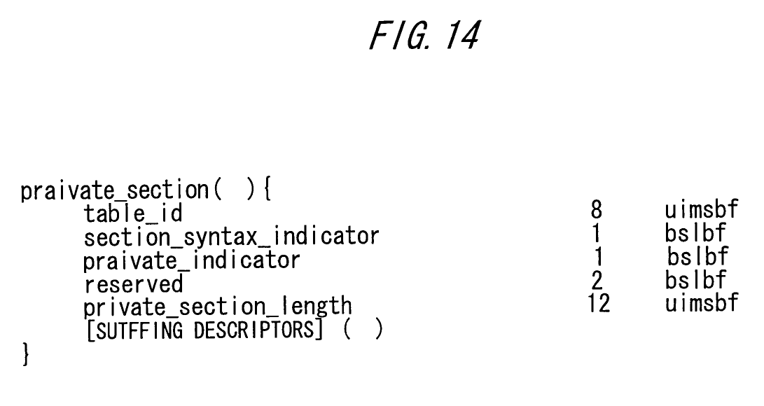

FIG. 14 shows the stuffing descriptor buried into the private section determined by ISO/IEC13818-1, in the case where the stuffing descriptor is being transmitted. Here, in a similar way, an example using the private section has been given. There are also methods using a private data area in the DSM-CC section, and private data area in the PES packet.

A table identifier for transmitting the stuffing descriptor is buried into table_id (8-bit). “0” is buried into section_syntax_indicator (1-bit). “1” is buried into private_indicator (1-bit). The number of bytes of the subsequent private_data_byte is buried into private_section_length (12-bit). The stuffing descriptors shown in FIG. 13 are buried into private_data_byte.

[Transport Stream Structure]

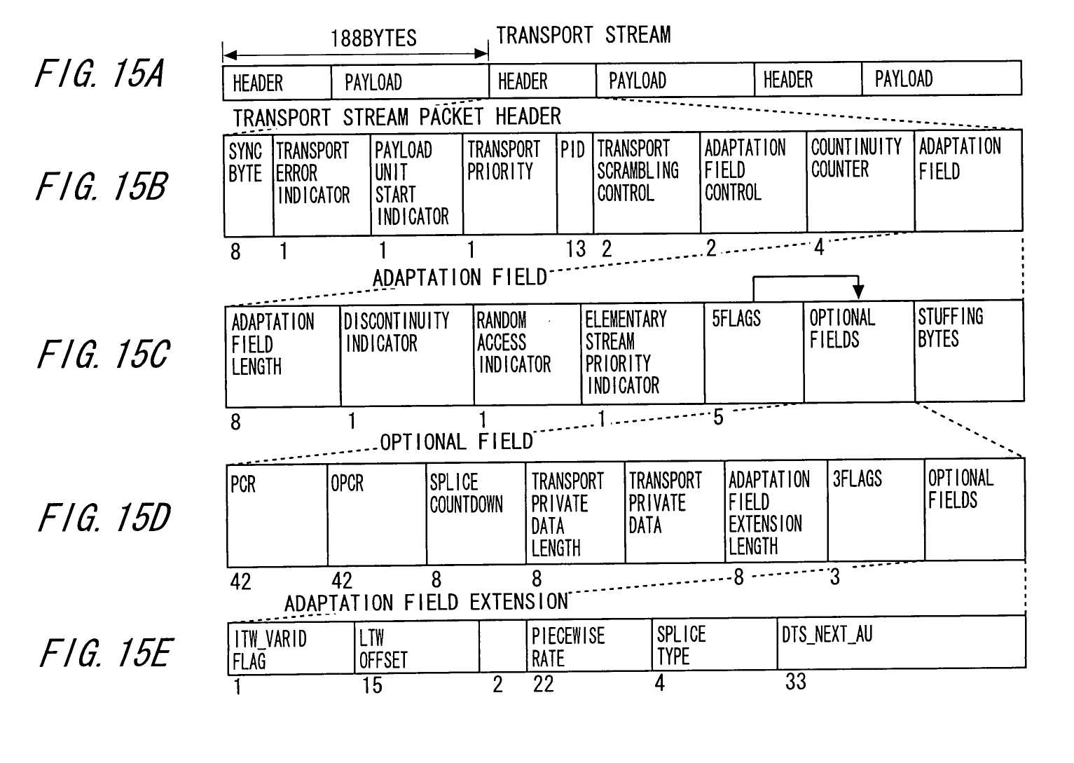

FIG. 15 through FIG. 22 show transport stream structures determined by ISO/IEC13818-1, 6, and ARIB STD-B24.

[Transport Stream]

FIG. 15(A) shows the transport stream as a 188-byte sequence of transport stream packets defined in ISO/IEC13818-1. Here, “header” is a transport stream packet header defined in ISO/IEC13818-1, and “payload” is a transport stream packet payload defined in ISO/IEC13818-1.

[Transport Stream Packet Header]

FIG. 15(B) shows the transport stream packet header defined in ISO/IEC13818-1 and JT-H222.0. The explanation here is based on the field semantics definitions for transport packet layers of sections JT-H222.0, 2.4.3.3.

Sync_Byte:

Sync_byte is a fixed 8-bit field. The value is “01000111 (0×47)”. When selecting a regularly occurring value like the PID in another field, sync_byte emulation cannot be avoided.

Transport_Error_Indicator:

Transport_error_indicator is a 1-bit flag. When it is set to “1”, this indicates that there is at least a 1-bit error transport stream packet which cannot be corrected. This bit can be set to “1” by using an entity outside the transport layer. When it is set to “1”, it cannot be reset to “0” unless the erroneous bit value is corrected.

Payload_Unit_Start_Indicator:

Payload_unit_start_indicator is a 1-bit flag. It has a normative meaning with respect to the transport stream packet that transmits the PES packet or the PSI data.

In the case where the transport stream packets include the PES packet data, payload_unit_start_indicator has the following meaning. “1” indicates that the transport stream packet payload starts from the first byte of the PES packet. “0” indicates that the PES packet has not started in this transport stream packet. If the payload_unit_start_indicator is set to “1”, then only 1 PES packet starts at a transport stream packet. This applies in the case of a stream_type6 private stream as well.

In the case where the transport stream packet payload includes the PSI data, payload_unit_start_indicator has the following meaning. In the case where the transport packet transports the first byte of the PSI section, payload_unit_start_indicator must be “1”, and this indicates that the first byte of the transport stream packet payload is transmitting the pointer_field. If the transport stream packet is not transmitting the first byte of the PSI section, then the payload_unit_start_indicator must be “0”, and this indicates that there is no pointer_field in the payload. This applies in the case of the stream_type5 private stream as well. In the case of a null packet, payload_unit_start_indicator must be “0”.

Transport_Priority:

Transport_priority is a 1-bit identifier. When it is set to “1”, this indicates that related packets have a higher priority than the other packets which have the same PID but are not set to “1”. The transport mechanism can use this to determine the priority levels within 1 elementary stream. Depending on the application, this transport_priority field can be modified by an encoder or a decoder.

PID:

The PID (Packet Identifier) is a 13-bit field. It indicates the type of data stored in the packet payload. A PID value “0x0000” is secured in a program association table. A PID value “0x0001” is secured in a conditional access table. A PID value “0x0002˜0x000F” is reserved. A PID value “0x1FFFF” is secured in a null packet.

Transport_Scrambling_Control:

This 2-bit field indicates a transport stream packet payload scrambling mode. In a case where the transport stream packet header and an adaptation field exist, the adaptation field must not be scrambled. In the case of a null packet, the value in the transport_scrambling_control field must be set to “00”.

Adaptation_Field_Control:

This 2-bit field indicates that after the transport stream packet header, the adaptation field and/or the pay load will come. A TTC standard JT-H222.0 decoder should discard the transport stream in which the value of the adaptation_field_control field is “00”. In the case of the null packet, the value in adaptation_field_control must be set to “01”.

Continuity_Counter:

Continuity_counter is a 4-bit field which increases incrementally with each transport stream packet having the same PID. Continuity_counter changes from the maximum value to “0”. The continuity_counter must not be incrementally increased when the adaptation_field_control is “00” or “10”.

In the transport stream, the forwarded packet can be sent as a transport stream packet in which 2 identical PIDs follow one after the other. Only 2 packets continuously are sent one after the other. Those packets which are continuously sent one after the other have the same continuity_counter value as the original packet, and the adaptation_field_control field must be “01” or “11”. In the packets, which are continuously sent one after the other, each byte of the original packet should be identical, with the exception that only in the case where there is the program clock reference (PCR), the correct value should be encoded.

In a case where continuity_counter in a given transport stream packet which differs by 1 from continuity_counter in the immediately previous transport stream packet with the same PID, or a condition precludes the incremental increase (e.g., “00” or “10” is set into adaptation_field_control, or the above-mentioned packets are sent one after the other), it is assumed that the continuity_counter was continuous. In a case where a discontinuity_indicator is set to “1”, a cyclical counter a discontinuity_indicator can be made discontinuous. In the case of the null packet, the continuity_counter value is not defined.

Adaptation_Field:

Explained below with reference to FIG. 15(C).

Data_Bytes:

Data bytes must by the PES packets indicated by the PID, or the PSI section, or the packet stuffing bytes after the PSI section, or a continuous data bytes of private data which are not in any of those structures. In the case of the null packet with the PID value “0x1FFF”, any value can be assigned to the data-bytes. Their quantity “N” is determined as a value produced by subtracting the number of bytes in adaptation_field ( ) from 184.

(Adaptation Field)

FIG. 15(C) shows the adaptation field of the transport stream packet header defined in ISO/IEC13818-6 and JT-H.222.0. The explanation given here is based on definitions for field semantics of sections JT-H222. 0,2.4.3.5 of the adaptation field. adaptation_field_length:

This is an 8-bit field, and it determines the number of bytes in the adaptation field, immediately following the adaptation_field_length field. A value of “0” is used to insert 1-byte stuffing into a transport stream packet. In a case where the value of adaptation_field_control is “11”, the value of the adaptation_field_length must be between 0 and 182. In the case where the value of the adaptation_field_control is “10”, the value of the adaptation_field_length must be 183.

In the case of the transport stream packet transmitting the PES packet, if there is insufficient PES packet data to completely satisfy the payload bytes in the transport stream packet, then the stuffing becomes necessary. The stuffing is performed by defining the adaptation field longer than the sum of the lengths of the data materials included in it. Accordingly, the payload bytes existing after the adaptation field, and the valid PES packet data, are accurately adapted. Excess void in the adaptation field is filled with the stuffing bytes.

This is the sole stuffing method permitted with transport stream packets for transmitting PES packets. One more stuffing method is described in sections JT-H.222.0, 2.4.4 for transport stream packets that transfer the PSIs.

Discontinuity_Indicator:

This is a 1-bit field. When discontinuity_indicator is set to “1”, this indicates that the discontinuity state in the current transport stream packet is true. If discontinuity_indicator is set to “0” or if it does not exist, the discontinuity state is false. Discontinuity_indicator is used to show 2 types of discontinuity, the system time base discontinuity and the cyclical counter discontinuity.

The system time base discontinuity is shown using discontinuity_indicator in the transport stream packet of the PID designated as PCR_PID. In the case of a true discontinuity state in the transport stream packet having the PID designated as PCR_PID, the next PCR of the transport stream packet having the same PID expresses a new system time clock sample value of a corresponding program. The point of discontinuity of the system time base is defined as the instant in time when the first byte of the packet containing the new system time base PCR arrived at the T-STD (Transport System Target Decoder) input. In the packet where the system time base discontinuity occurred, the discontinuity_indicator bit must be set to “1”.

In an identical PCR_PID transport stream packet existing before the packet that contains the new system time base PCR, the discontinuity_indicator bit may be set to “1”. In this case, when the discontinuity_indicator bit is set to “1”, the discontinuity_indicator bit must be set to “1” in all of the transport stream packets that have the same PCR_PID, including the transport stream packet having the new system time base's first PCR. At least 2 new system time base PCRs must be received after the occurrence of the discontinuity in the system time base, but before the discontinuity in the next system time base. Furthermore, except in the case where the trick mode is true, data of 2 or more system time bases may never be present at the same time within the T-STD buffer set for 1 program.

Before the system time base discontinuity occurs, the first byte of the transport stream packet that contains the PTS (Presentation Time Stamp) or the DTS (Decoding Time Stamp) referencing the new system time base, must arrive at the T-STD input. After the system time base discontinuity occurs, the first byte of the transport stream packet that contains the PTS or the DTS referencing the previous system time base, must arrive at the T-STD input. Here, the PTS is a field existing in the PES packet header to show the time when a presentation unit is to be displayed at a system target decoder.

Discontinuity in continuity_counter is shown through use of discontinuity_indicator in any transport stream packet. In the case of a true discontinuity state in a transport stream packet where the PID is not designated in the PCR_PID, that packet's continuity_counter may be treated as discontinuous with respect to the previous PID transport stream packet that has the same PID. In the case of the true discontinuity in the transport stream packet where the PID is designated in the PCR_PID, the continuity_counter may be treated as discontinuous only in the packet where the system time base discontinuity occurs.

In the case where the discontinuity in the transport stream packet is true and the same packet's continuity_counter is discontinuous with respect to the previous transport stream packet with the same PID, a discontinuous point occurs in the cyclical counter. The discontinuous point in the cyclical counter can occur not more than a maximum of 1 time between the start of the discontinuity state and the end of the discontinuity state. Furthermore, regarding all the PIDs which are not designated in PCR_PID, in the case where the discontinuity_indicator of a particular PID packet is set to “1”, the discontinuity_indicator may be set to “1” in the discontinuity_indicator of the subsequent transport stream packet having the same PID. However, the discontinuity_indicator cannot be set to “1” in the 3^{rd} or subsequent transport stream packet having the same PID.

After occurrence of the discontinuity in the cyclical counter in the transport stream packet designated as containing elementary stream data, the first byte of the elementary stream data in the transport stream packet with the same PID must be the first byte in the elementary stream access point or, in the case of images, it must be the elementary stream access point or the first byte of sequence_end_code after the access point.

A transport stream packet which has a PID that is not designated as PCR_PID, and where cyclical counter discontinuity has occurred, and which contains elementary stream data with PTS or DTS, must arrive at the T-STD input after the point of discontinuity in the system time base for creating a related program. In the case where the discontinuity state is true, when 2 transport stream packets occur one after the other with the same PID having the same continuity_counter value and the adaptation_field_control value of “01” or “11”, the 2^{nd} packet may be discarded. The transport stream packet must not be constructed in such a way that damage occurs to the PES packet payload data or the PSI data due to the packet being discarded in this way.

In a transport stream packet containing PSI information, after a discontinuity_indicator field is set to “1”, discontinuity may occur one time in the PSI section version_number. When this type of discontinuity occurs, the program's version number having a TS_program_map_section version must be sent with section_length==13, current_next_indicator==1. At this time, there exists no more program_descriptor nor the elementary stream that is described. After that, for each program which is affected by this change, it becomes necessary to receive the TS_program_map_section version, which includes the complete definition of the program and increases by 1, and the current_next_indication. This indicates the version number change in the PSI data.

Random_Access_Indicator:

Random_access_indicator is a 1-bit field. It indicates that the current transport stream packet and the next transport stream packet having the same PID contain information for assisting random access at this point. It is determined that when this field is set to “1”, the next PES packet starting at the payload of the transport stream packet having the current PIS must include the first byte of an image sequence header if the PES stream type is 1 or 2. Furthermore, in a case where the PES stream type is 3 or 4, the PES packet must include the first byte of an audio frame. Moreover, in the case of images, the Presentation Time Stamp (PTS) must be present within the PES packet containing the first picture after the sequence header In the case of audio, the Presentation Time Stamp (PTS) must be present in the PES packet containing the first byte of an audio frame. The random_access_indicator in the PCR_PID may be set to “1” in the transport stream packet containing the PCR field.

Elementary_Stream_Priority_Indicator:

Elementary_stream_priority_indicator is a 1-bit field. This field indicates a priority level in the elementary stream data being transmitted inside the payload of a transport stream packet in packets that have the same PID. “1” indicates that the payload has a higher priority level than the payloads of other transport stream packets. In the case of images, this field can be set to “1” only in a case that includes 1 or more bytes of a slice in which the payload is intra-coded (encoded within the frame). A value of “0” indicates that the payload has the same priority level as all the other packet payloads that are not set to “1”.

PCR_Flag:

PCR_flag is a 1-bit flag. “1” indicates that the adaptation field contains a PCR field encoded in 2 parts. A value of “0” indicates that the adaptation field does not contain a PCR field.

OPCR_Flag:

OPCR_flag is a 1-bit flag. “1” indicates that the adaptation field contains an OPCR field encoded in 2 parts. A value of “0” indicates that the adaptation field does not contain an OPCR field.

Splicing_Point_flag:

Splicing_point_flag is a 1-bit flag. When this is set to “1”, this indicates that a splice_countdown field determining the generation of an editing point must be present in the corresponding adaptation field. A value of “0” indicates that the splice_countdown field does not exist in the adaptation field.

Transport_Private_Data_Flag:

Transport_private_data_flag is a 1-bit flag. “1” indicates that the adaptation field contains private_data of 1 byte or more. A value of “0” indicates that the adaptation field does not contain private_data.

Adaptation_Field_Extension_Flag :

Adaptation_field_extension_flag is a 1-bit field. When this is set to “1”, this indicates that expansion is present in the adaptation field. A value of “0” indicates that the expansion does not exist in the adaptation field.

[Optional Field]

FIG. 15(D) shows an optional field of the adaptation field of the transport stream packet header defined in ISO/IEC13818-1 and JT-H222.0. The explanation here is based on the field semantics definitions for adaptation fields of sections JT-H222.0, 2.4.3.5.

PCR:

Program_clock_reference_base, program_clock_reference_extension (PCR) is a 42-bit field encoded in 2 parts. One is program clock_reference_base, and this is the 33-bit field, with its value shown at PCR_base(i) in the expression [1] below. The other is program_clock_reference_extension, and this is a 9-bit field, with its value shown at PCR_ext(i) in the expression [2] below. PCR indicates a predicted arrival time of the bytes at the system target decoder input, including the last bit of program_clock_reference_base.

In a case where the PCR field does exist in the transport stream packet containing an audio or image elementary stream, the PCR must be valid with respect to the time base of the elementary stream. See sections JT-H.222.0,2.7.2 for conditions required for the encoding frequency.

OPCR:

Original_program_clock_reference_base, original_program_clock_reference_extension (OPCR) is optional, and it is a 42-bit field encoded in two parts. The 2 parts, a basic part and an extended part, are each encoded similarly to the 2 corresponding parts of the PCR field. The presence of the OPCR is indicated by an OPCR_flag. The OPCR field needs to be encoded only in transport stream packets where the PCR field is present. The OPCR may be permitted in the case of the single program, and in the case of the multiple program transport streams.

The OPCR supports the reconstruction of the single program's transport stream from another transport stream. In a case where an original single program transport stream is to be reconstructed, the OPCR may be copied to the PCR field. The PCR, which is obtained in this way, is only valid in the case where all of the transport streams of the original single program are reconstructed. This transport stream probably includes some sort of PSI and private package that was present at least in the original transport stream, and other private adjustment is probably necessary. This means that the OPCR must be an identical copy of the PCR pertaining to the transport stream of the original, single program.
OPCR (i)=OPCR_base (i)×300+OPCR_{—}ext (i)
Here,
OPCR_base (i)=((system_clock_frequency×t (i)) DIV 300) %2³³ [1]
OPCR_{—}ext (i)=((system_clock_frequency×t (i)) DIV 1) %300 [2]

The decoder ignores the OPCR field. The OPCR field must not be modified by the multiplexer or the decoder.

Splice_Countdown:

Splice_countdown is an 8-bit field, expressing either a positive or a negative value. The positive value determines the number of remaining transport stream packets having the same PID, after the related transport stream packets and until reaching the editing point. The transport stream packets that are continuously sent one after the other and the transport stream packet that contains the adaptation field are eliminated. The editing point is positioned immediately after the final byte of the transport stream packet that has the related splice_{—}countdown field value of “0”.

In a transport stream packet where the value of the splice_countdown field is “0”, the final byte of the transport stream packet's payload must be an encoded audio frame or a final byte of a picture. In the case of images, the corresponding access unit may end at sequence_end_code, but not necessarily end thereat. The subsequence transport stream packet having the same PID can include a different elementary stream of the same stream type.

The payload of the subsequent transport stream packet with the same PID (excluding packets sent one after the other and packets with no payloads) must start at the first byte of the PES packet. In the case of audio, the PES packet payload must start at the access point. In the case of images, the PES packet payload must start at an access point or at the sequence_end_code which has an access point after it.

Therefore, the previous, encoded audio frame or picture must by aligned with the packet border, or must be padded such that it aligns there. A countdown field may also be present after the editing point. In a case where the splice_countdown is a negative number and the value is minus n (−n), this indicates that the related transport stream packet is n number of packets behind the editing point. Packets, which are continuously, sent one after the other, and packets, which have no payload, are excluded.

The access point in this section is defined as follows. Specifically:
Images: The first byte of video_sequence_header
Audio: The first byte of the audio frame.
   Transport_Private_Data_Length:

Transport_private_data_length is an 8-bit field. This field determines the number of bytes in private_data, which is immediately after the transport_private_data_length field. The number of bytes in private_data must be set such that the private data does not exceed the adaptation field.

Transport_Private_Data:

Transport_private_data is an 8-bit field. According to TTC standards, this field must not be defined.

Adaptation_Field_Extension_Length:

Adaptation_field_extension_length is an 8-bit field. This field shows the number of bytes of the expanded adaptation field data following immediately after this field. This includes reserved bytes, in the case where such exist.

[Adaptation Field Extension]

FIG. 15(E) shows adaptation field extension of the optional field of the adaptation field of the transport stream packet header defined in ISO/IEC13818-1 and JT-H222.0. The explanation here is based on the field semantics definitions for adaptation fields of sections JT-H222.0, 2.4.3.5.

Ltw_Flag:

Ltw_flag (legal_time_window_flag) is a 1-bit field, and when it is set to “1”, this indicates the presence of an ltw_offset field.

Piecewise_Rate_Flag:

This is a 1-bit field, and when it is set to “1”, this indicates the presence of a piecewise_rate field.

Seamless_Splice_Flag:

This is a 1-bit field, and when it is set to “1”, this indicates the presence of splice_type and DTS_next_AU fields. A value of “0” indicates that neither the splice_type nor the DTS_next_AU field is present. This field may not be set to “1” in a transport stream packet where the splicing_point_flag is not set to “1”. Once it is set to “1” in a transport stream packet where the splice_countdown is positive, this flag must be set to “1” in all the subsequent transport stream packets having the same PID where the splicing_point_flag is set to “1”, until (and including) a packet in which splice_countdown is “0”. In the case where this flag is set, if the elementary stream that is sent with the PID is the audio stream, then the splice_type must be set to “0000”. If the elementary stream that is sent with the PID is the image stream, then the conditions indicated by the value in splice_type must be satisfied.

Ltw_Valid_Flag:

Ltw_valid_flag (legal_time_window_valid_flag) is a 1-bit field, and when it is set to “1”, this indicates that the ltw_offset value is valid. A value of “0” indicates that the value in the ltw_offset field is still undefined.

Ltw_Offset

Ltw_offset (legal_time_window_offset) is a 15-bit field, and it's value is defined only when the ltw_valid_flag is “1”. When this is defined, the ltw_offset field satisfies the following, in terms of units of 300/fs seconds. Here, fs is the system clock frequency of the program belonging to the PID.
offset=t1 (i)−t (i)
ltw_offset=offset//1
Here, i is an index in the first byte of the transport stream packet, and offset is a value that is encoded in this field, and t(i) is a T-STD arrival time of the i byte. Furthermore, t1 (i) is an upper limit of a chronological interval called a legal time window corresponding to the transport stream packet.

The legal time window has the following properties. If the transport stream is transferred to the T-STD at time t1 (i), in other words at the end of the legal time window, and all the other transport stream packets of the same program are transmitted at the end of the legal time window, then the following can be said.

(1) In the case of images, an MBn buffer for the PID, which is located at the T-STD, must have elementary stream data of no more than 184 bytes at the time when the first byte of the transport stream packet's payload is inputted, and no buffer violation whatsoever may occur at the T-STD.

(2) In the case of audio, a Bn buffer for the PID, which is located at the T-STD, must have elementary stream data of no more than Bsdec+1 bytes at the time when the first byte of the transport stream packet's payload is inputted, and no buffer violation whatsoever may occur at the T-STD.

One more time t0 (i) can be determined, based on the size of the buffer MBn and the data transfer rate between MBn and Ebn. At this time, if the packet is transmitted sometime during the time section [t0 (i), t1 (i)], then no buffer violation whatsoever will occur. This time interval is called the legal time window. The value of t0 is not defined according to the standard being used here.

The information in this field is intended for a remultiplexer or other such device requiring this information to reconstruct the status at the buffer MBn.

Piecewise_Rate:

This is a 22-bit field, and it is defined only when ltw_flag and ltw_valid_flag are set to “1”. In the case where this field is defined, it is a positive integer for determining a hypothetical bit rate R which is used to define the ending time of the legal time window of the subsequent transport stream packet which does have the same PID and which does not contain the legal_time_window_offset field.

The transport stream packet and the first byte of N number of subsequent transport stream packets having the same PID have indexes of Ai, Ai+1, . . . , Ai+N. At this time, t1 (Ai+j) must be determined as follows.
t1 (Ai+j)=t1 (Ai)+j*188*8 (bits/byte/R)
Here, j is a value between 1 and N.

All of the packets from this packet to the next packet with the same PID containing the legal_time_window_offset field, must be treated as having values.
offset=t1 (Ai)−t (Ai)
This corresponds to a value t1 (.) which is calculated using the above-mentioned expression that is encoded into the legal_time_window_offset field.

The meaning of this field is not defined in the case where this field is present in the transport stream packet without the legal_time_window_offset field.

Splice_Type:

This is a 4-bit field. From the first occurrence of this field to (and including) a packet where the value of the splice_countdown field is “0”, the splice_type must have the same value in all the subsequent transport stream packets which have the same PID and in which the splice_type field is present. If the elementary stream transmitted with the PID is the audio stream, then this field must be “0000”. If the elementary stream transmitted with the PID is the image stream, then this field shows a condition requiring that this elementary stream be factored into splicing. Those conditions are defined as functions of a profile, level, and splice_type in JT-H222.0 (see Table 2-7 through Table 2-16).

DTS_next_AU:

DTS_next_AU (decoding_time_stamp_next_access_unit) is a 33-bit field constituted of 3 parts. This field shows a first access unit decoding time that will come after the editing point, in the case where there is continuity and periodic decoding at the editing point. This decoding time is expressed in a valid time base in a transport stream packet where splice_countdown is “0”. From the first occurrence of this field and up to (and including) the packet where the value of the splice_countdown field is “0”, the value must be the same in subsequent transport stream packets of the same PID having that field.

Stuffing_Byte:

This is a fixed 8-bit value of “11111111”. It can be inserted by the encoder and discarded by the decoder.

<Program Specification Information Pointer>

Explanation of the program specification information pointer is based on JT-H222.0,2.4.4.1, and explains an ISO/IEC13818-1 pointer field.

Pointer_field is an 8-bit field. Its value must be the number of bytes from immediately after pointer_field to the first byte of the first section in the payload of the transport stream packet. A pointer_field value of “0x00” indicates that the section starts immediately after pointer_field. In a case where at least 1 section starts at a given transport stream packet, the payload_unit_start_indicator field must be set to “1”, and the first byte of the transport stream packet must contain a pointer. In a case where the section does not start at the given transport packet, payload_unit_indicator must be set to “0”, and the pointer may not be sent in the payload of the transport packet.

[Private Section]

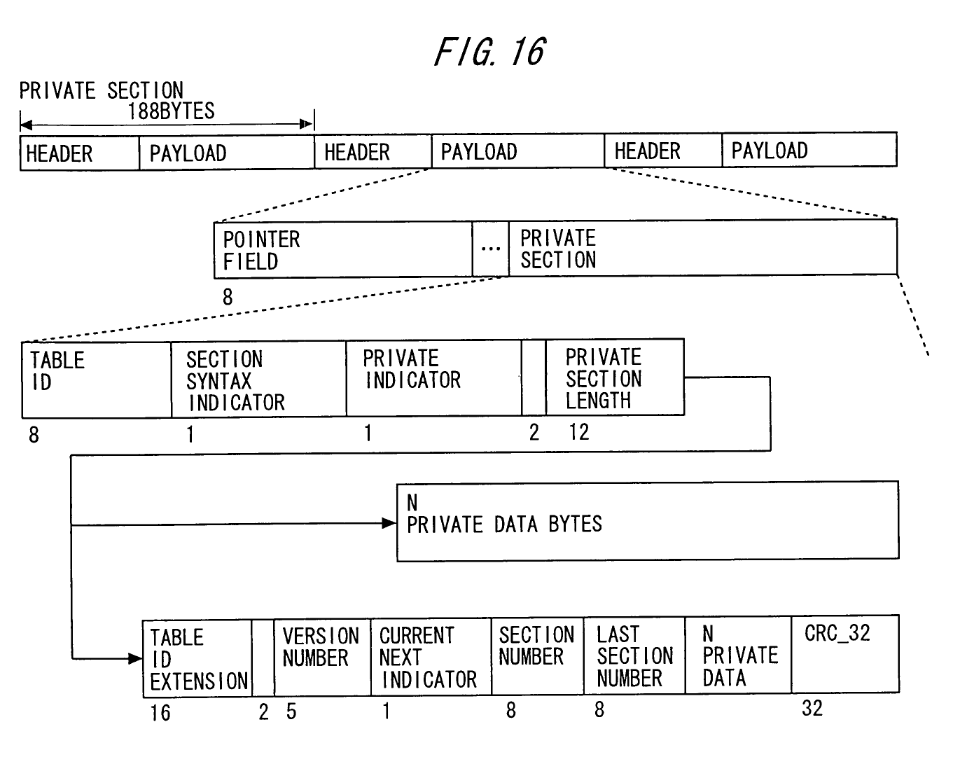

FIG. 16 shows a private section defined in ISO/IEC13818-1 and JT-H222.0. The explanation here is based on the field semantics for private fields of sections JT-H222.0, 2.4.4.10.

Table_Id:

This is an 8-bit field. Its value distinguishes the private table to which the section belongs. It is acceptable to use only values defined in “user private” in JT-H222.0 (see Table 2-26).

Section_Syntax_Indicator:

This is a 1-bit field. In a case where it is set to “1”, this private section indicates that private_section_length field transition occurs in accordance with generic section syntax. In a case where this field is set to “0”, this indicates that private_data_byte follows immediately after the private_section_length field.

Private_Indicator:

This is a 1-bit flag. It can be defined by the user. In the future TTC cannot define it.

Private_Section_Length:

This is a 12-bit field. It determines the remaining bytes in the private section from immediately after private_section_length until the end of private_section. This field cannot exceed “4093(0x FFD)”.

Private_Data_Byte:

The private_data_byte field can be defined by the user. In the future TTC cannot define it.

Table_Id_Extension:

This is a 16-bit field. Its usage and value are defined by the user.

Version_Number:

This is a 5-bit field and it indicates a version number of the private_section field. In a case where the information transmitted in private_section has been modified, the version number must increase incrementally 1 by 1 at modulo 32. When current_next_indicator is set to “0”, its version_number field must be equal to the version_number field in the private_section which has the same table_id and section_number which can be applied next.

Current_Next_Indicator:

This is a 1-bit field. In a case where it is set to “1”, the private_section which is being sent is currently usable. In a case where current_next_indicator is set to “1”, the version_number must be equal to a private_section which is currently usable. In a case where this bit is set to “0”, the private_section which is being sent cannot be used yet, and must be the private_section which has the same table_id and section_number which are valid next.

Section_Number:

This is an 8-bit field, showing the private_section number. The section_number in the first section in the private table must be “0x00”. This must increase incrementally 1 by 1 each time a new section is added to the private table.

Last_Section_Number:

This is an 8-bit field. This section determines the number of the last section, which is to say the section with the greatest section_number, in the private table, which is a portion of this section.

CRC_{—}32:

This is a 32-bit field. This field has a CRC value such that a register of the decoder (defined in documents B appended to JT-H.222.0) outputs “0” after the entire private section has been processed.

<DSM-CC Section (Transmission of DII Message)>

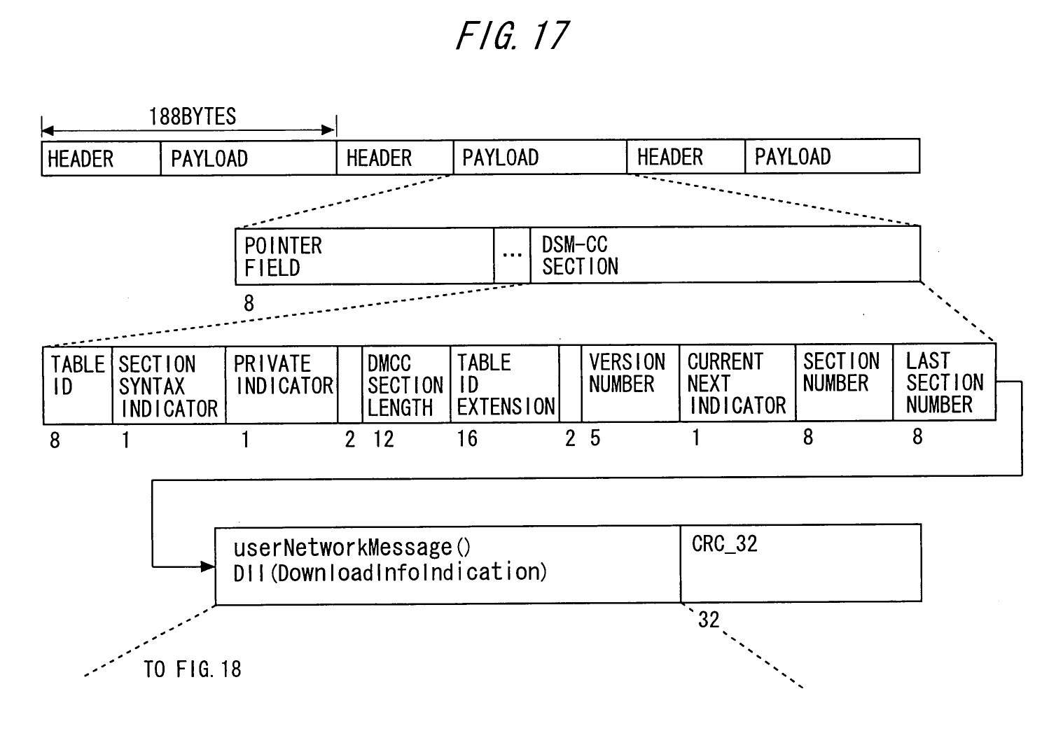

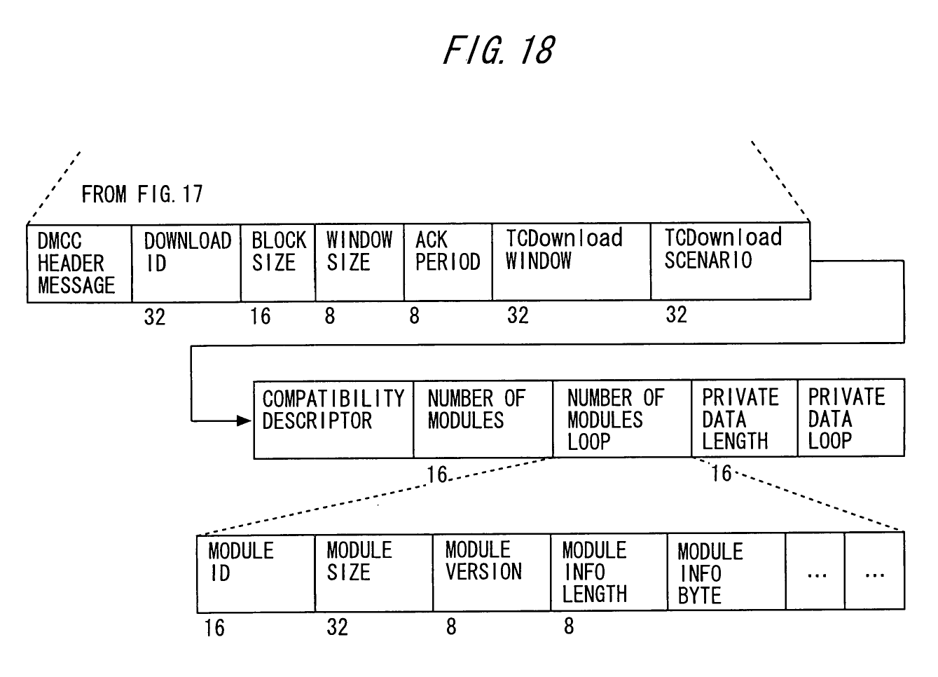

FIG. 17 shows a DSM-CC section (transmission of the DII message) defined by ARIB STD-B24. The explanation given here is based on ARIB STD-B24 volume 3, 6.5 “DSM-CC Section Syntax”.

Table_Id:

(Table Identifier) This 8-bit field stores a number for identifying the type of data in the payload of the DSM-CC section. Depending on the value in this field, a specific symbolization rule is applied in the subsequent field in the DSM-CC section. The value of the table identifier is as shown in Table 1, in accordance with ISO/IEC13818-6.

TABLE 1

| table_{—} | | |
|---|---|---|
| id | DSM-CC Section Type | ISO/IEC13818-6 Definitions |
| 0x3A | Reserved | Multi-Protocol Capsulization |
| 0x3B | DII Message | U-N Message Containing DII |
| 0x3C | DDB Message | See Left |
| 0x3D | Stream Descriptors | See Left |
| 0x3E | Private Data | See Left |
| 0x3F | Reserved | See Left |

Section_Syntax_Indicator

(Section Syntax Indicator) In this 1-bit field, a “1” indicates that CRC_{—}32 is present at the end of the section, and “0” indicates that a checksum is present. This is always “1” when transmitting the DII message and the DDB message.

Private_Indicator:

(Private Indicator) This 1-bit field stores the inverse value of the value shown in the section syntax indicator.

Dsmcc_Section_Length:

(DSM-CC Section Length) This 12-bit field indicates byte length from immediately after this field to the end of the section. The value in this field never exceeds “4093”.

Table_Id_Extension:

(Table Identifier Extension) This 16-bit field is set as follows depending on the table Identifier. When the table Identifier is “0x3B”, the last 2 bytes of a transaction identifier are set. When the table identifier is “0x3C”, a module identifier is set.

Version_Number:

(Version Number) This 5-bit field is set as follows depending on the table identifier. When the table identifier is “0x3B”, this field is set to “0”. When the table identifier is “0x3C”, the last 5 bits of the module version number are set.

Current_Next_Indicator:

(Current Next Indicator) When this 1-bit indicator is set at “1”, this indicates that a sub-table is the current table. When it is set at “0”, this indicates that the sub-table being sent is not applied yet and will be used as the next sub-table. When the table identifier is “0x3A” through “0x3C”, this field is always designated as “1”.

Section_Number:

(Section Number) This 8-bit field represents a section number. It represents the section number of the first section in the sub-table. In a case where the section transmits the DII message, the field stores the message number of the DII message. In the case of the DDB message, the field stores the last 8 bits of the DDB block number.

Last_Section_Number:

This 8-bit field indicates the number of the last section, which is to say the section with the greatest section_number, to which this section belongs.

UserNetworkMessage ( ):

DII (DownloadInfoIndication) message is stored in here.

DownloadDataMessage ( ):

DDB (DownloadDataBlock) message is stored in here.

Data Structure of DII (DownloadInfoIndication):

FIG. 18 shows a data structure of DownloadInfoIndication defined by ARIB STD-B24. The explanation given here is based on ARIB STD-B24 volume 3, section 6.2 “DownloadInfoIndication (DII) Message”.

DsmccAdaptationHeader ( ):

This is a DSM-CC message header.

DownloadId:

(Download ID) This 32-bit field serves as a label for uniquely identifying the carousel. In a case where the DII is sent by operation of a data event due to rules and the like of the encoding format, a data_event_ID is encoded into bit 28-31 of the download ID. In any other case, the uniqueness of the range and value is determined by the operation.

Data_Event_Id:

(Data Event ID) The 4-bit field at bit 28-31 in the download ID is an identifier for distinguishing between chronologically neighboring data events in the same service, while simultaneously avoiding erroneous reception of the data carousel of the data event and the local contents transmitted by the event message.

BlockSize:

(Block Size) This 16-bit field indicates the byte size of each block except at the end of the module, in the data that is transmitted by the DDB message.

WindowSize:

This 8-bit field is not used in the data carousel transmission, and its value is set to “0”.

Ackperiod:

This 8-bit field is not used in the data carousel transmission, and its value is set to “0”.

TCDownloadWindow:

This 32-bit field is not used in the data carousel transmission, and its value is set to “0”.

TCDownloadScenario:

This 32-bit field indicates the timeout time from when the download started to the time when it finishes, in microsecond units.

CompatibilityDesciptor ( ):

This area stores a compatibilityDescriptor( ) structure determined in ISO/IEC13818-6. In a case where the content of the compatibilityDescriptor ( ) structure is not necessary, the descriptorCount is set to “0x0000”. As a result, the size of this area becomes 4 bytes.

NumberOfModules:

(Number of Modules) This 16-bit field shows a number of modules described in a loop following the DII message.

ModuleId:

(Module ID) This 16-bit field stores Module IDs for the modules described in a subsequent moduleSize field, a moduleVerison field, and a moduelInfoByte area.

ModuleSize:

(Module Size) This 32-bit field shows the byte size of the module. This field is set to “0” in a case where the byte size of the module is undetermined.

ModuleVersion:

(Module Version) This 8-bit field shows the version number of the module.

ModuleInfoLength:

(Module Information Length) This 8-bit field shows the byte size of the subsequent module information areas.

ModuleInfoByte:

(Module Information) This 8-bit field stores descriptors relating to modules in a series of areas. The descriptors stored in this area are descriptors defined in sections JT-H.222.0,6.2.3.

PrivateDataLength:

(Private Data Length) This 16-bit field shows the byte length of the subsequent private data area.

PrivateDataByte:

(Private Data) This is an 8-bit field. In a series of areas, descriptor formats are used to store data structures defined by the data encoding formats, and data structures defined by each company. The meanings of descriptor tag values inserted into this area are defined in Table 2. Note that, in the definitions determined according to each data encoding format, it is also possible to use descriptors defined in sections JT-H.222.0,6.2.3, in order to show the valid information for all the modules inside the DII.

TABLE 2

| Descriptors' | |
|---|---|
| Tag Values | Meanings |
| 0x01˜0x7F | Reserved as tag values for descriptors inserted |
| | into module information area |
| 0x80˜0xBF | Range selectable for tag values of descriptors |
| | defined by company |
| 0xC0˜0xEF | Reserved as tag values for descriptors inserted |
| | into module information area |
| 0xF0˜0xFE | Reserved as tag values for information to be |
| | inserted into private area as determined |
| | separately for each data encoding format |

Data Structure of DmccMessageHeader ( ):

FIG. 19 shows dmccMessageHeader ( ) defined by ARIB STD-B24. The explanation given here is based on ARIB STD-B24 volume 3, section 6.2.2 “dmccMessageHeader ( ) Syntax and Semantics” and on section 6.4 “dmccAdaptationHeader ( ) Syntax”.

ProtocolDiscriminator:

This 8-bit field is set to “0x11”, and indicates that this message is the MPEG-2 and DSM-CC message.

DsmccType:

(DSM-CC Type) This 8-bit field shows the type of the MPEG-2, DSM-CC message, and it is set to “0x03” (U-N download message) in the DII message in the data carousel transmission.

MessageId:

(Message Type ID) This 16-bit field identifies the type of the DSM-CC message, and is set to “0x1002” for the DII message.

Transaction_Id:

(Transaction ID) This 32-bit field is an identifier having a message ID and version number function.

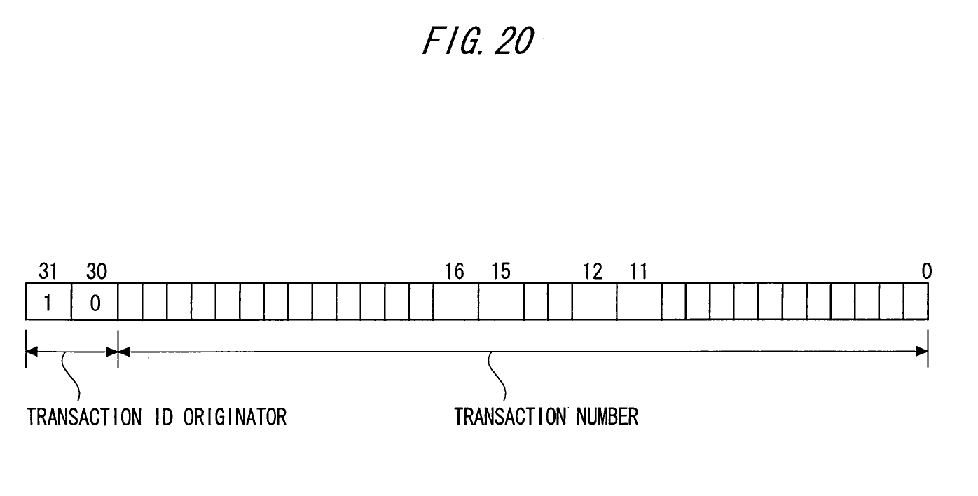

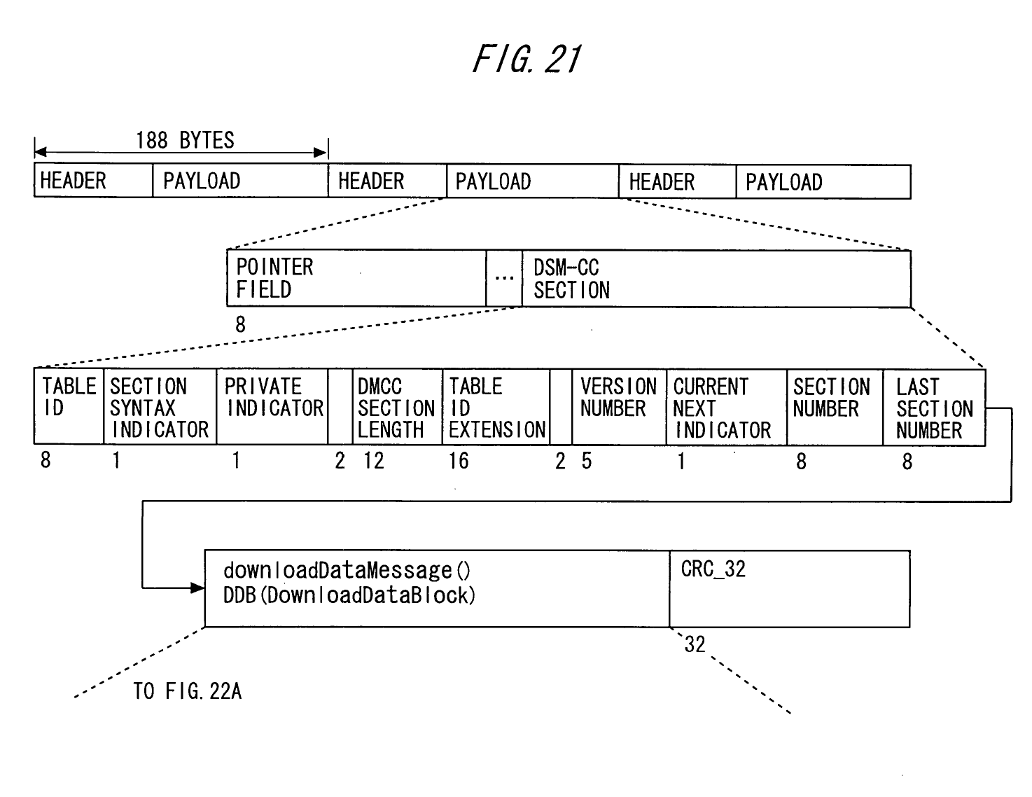

FIG. 20 shows a format of the transaction ID. The Transaction Number field in bit 0-29 uses the DII version ID exactly as determined in ISO/IEC13818-6. The value in bit 30-31 is set to “10” (the TransactionID assigned by the network), in accordance with definition for Transaction ID Originator as defined in ISO/IEC13818-6.

AdaptationLength:

(Adaptation Length) This 8-bit field shows the number of bytes of a dsmccAdaptationHeader ( ) area.

MessageLength:

(Message Length) This 16-bit field shows the number of bytes of the message as counted from immediately after this field. The value is the length of dsmccAdaptationHeader plus the length of the payload.

AdaptationType:

(Adaptation Type) This 8-bit field indicates the type of the adaptation. Table 3 shows correspondences between the value in this field and the adaptation format.

TABLE 3

| Adaptation | | |
|---|---|---|
| Type | Adaptation Formats | ISO/IEC13818-6 Definitions |
| 0x00 | Reserved | See Left |
| 0x01 | Reserved | DSM-CC ConditionalAcces. |
| 0x02 | Reserved | DSM-CC User ID |
| 0x03 | DIIMsgNumber | See Left |
| 0x04˜0x7F | Reserved | See Left |
| 0x80˜0xFF | User-defined | See Left |

The following adaptation types are actually used. In a case where a plurality of the DII messages are used, the DIIMsgNumber adaptation format of adaptation type “0x03” is stored in indsmccMessageHeader ( ) . The operation of the adaptation format of the user definition of adaptation type “0x80-0xFF” is left up to the company to determine.

DIIMsgNumber:

(DIIMessageNumber) This 8-bit field shows a DII message number.

<DSM-CC Section (Transmission of DDB Message)>

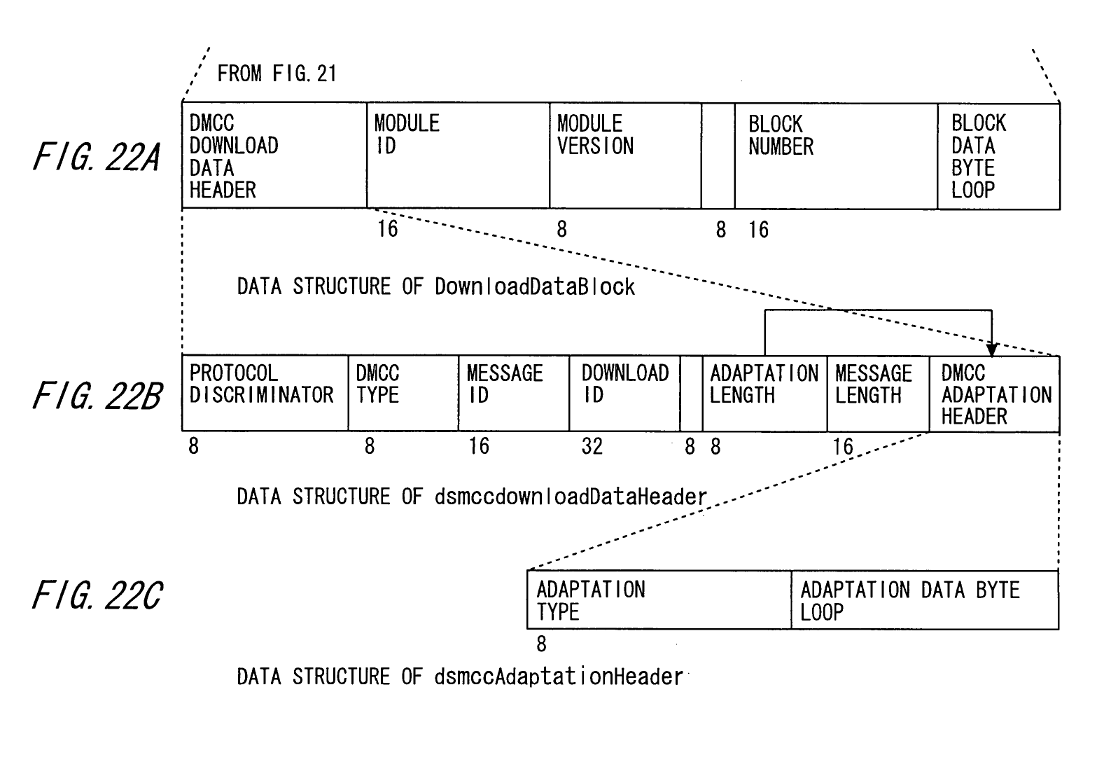

FIG. 21 shows a DSM-CC section (transmission of the DDB message) defined by ARIB STD-B24.

Data Structure of DDB (DownloadDataBlock):

FIGS. 22(A) to 22(C) show a data structure of DownloadDataBlock defined by ARIB STD-B24. The explanation given here is based on ARIB STD-B24 volume 3, section 6.3.1 “DDB Message Syntax and Semantics”.

DsmccDownloadDataHeader ( ):

Details are described below, with reference made to FIG. 22(B).

ModuleId:

(Module Identification) This is a 16-bit field, and it shows an identification number of the module belonging to this block.

ModuleVersion:

(Module Version) This is an 8-bit field, and it shows the version number of the module belonging to this block.

BlockNumber:

(Block Number) This is a 16-bit field, and it shows the position of this block within the module. The block number of the first block in the module must be “0”.

BlockDataByte:

(Block Data) This is an 8-bit field. A series of block data areas is equivalent to the DII block size, which is a block data length produced by evenly dividing the module. However, it may be smaller than the block size described in DII when the block number is the last one.

Data Structure of DsmccDownloadDataHeader:

FIG. 22(B) shows a data structure of dsmccDownloadDataHeader defined by ARIB STD-B24.

ProtocolDiscriminator:

This 8-bit field is set to “0x11”, and indicates that this message is the MPEG-2, DSM-CC message.

DsmccType:

(DSM-CC Type) This 8-bit field shows the type of the MPEG-2, DSM-CC message, and it is set to “0x03” (U-N download message) in the DDB message in the data carousel transmission.

MessageId:

(Message Type Identification) This 16-bit field identifies the type of the DSM-CC message, and is set to “0x1003” for the DDB message.

DownloadId:

(Download ID) This 32-bit field is set with the same value as the download ID in the corresponding DII message.

AdaptationLength:

(Adaptation Length) This 8-bit field indicates the number of bytes of the dsmccAdaptationHeader ( ) area.

MessageLength:

This 16-bit field indicates the number of bytes of the message, as counted from immediately after this field. It is the value produced by adding the payload length to the dsmccAdaptationHeader length.

DsmccAdaptationHeader ( ):

FIG. 22(C) shows a data structure of dsmccAdaptationHeader defined by ARIB STD-B24.

[DSM-CC Data Carousel Redundancy Elimination Processing]

FIG. 23 shows a flowchart of DSM-CC data carousel redundancy elimination processing performed in the transmission-side digital broadcast material transmitter (transmission-side device) 3, which is shown in FIG. 1 and FIG. 2.

This processing is software (program) processing performed by a CPU in the transmission-side device 3 shown in FIG. 2. According to this processing, the transmission-side device 3 eliminates the portions, which are in the 2^{nd} and subsequent cycles and are the same version numbers as the DSM-CC section containing the DII (DownloadInfoIndication) and the DSM-CC section, and replaces these with the private section P containing the carousel gap descriptor(s), which have less information volume.

The CPU performs the DSM-CC data carousel redundancy elimination processing according to the following sequence. Initialization processing:

In this processing, a 27 MHz self-running counter (FIG. 25) which is described below is reset. After that, the 27 MHz self-running counter's output data is monitored, while load settings and reset processing are performed for a 27 MHz self-running counter with a load function (FIG. 26) which is described below. Accordingly, in the PCR fluctuation suppression section A and the PCR fluctuation suppression section B, fluctuation can be suppressed, with respect to the PCR final byte that may be present in the adaptation field of the header of the transport stream packet (sometimes referred to as transport packet or TS), from one Sync byte through the 11^{th} Sync byte from the first one, counting the first one.

Further, a valid data extraction unit (including a Reed-Solomon decoding function) which is described below (FIG. 25) notifies whether the inputted TS is a 188-byte transport stream packet, or a transport stream packet that is in 204-byte units and is also Reed-Solomon encoded.

Pre-Processing TS Buffer Determination Processing:

This processing determines whether 1 TS-worth of valid data is present in the pre-processing TS buffer 13 shown in FIG. 2. Specifically, the number of valid data in the pre-processing TS buffer 13 is read out, and it is determined whether there is 1 TS worth of data. In the case where there is no such data (NO), the processing waits, and after other processing is performed in MISC processing described below, the pre-processing TS buffer determination processing is performed once again. In the case where such data is present (YES), the processing advances to TS extraction processing, which comes next.

TS Extraction Processing:

This processing extracts (reads out) the transport packet (1 TS-worth of data) from the pre-processing TS buffer 13. After the extraction, the procedure advances to TS saving processing, which comes next.

TS Saving Processing:

This processing saves the extracted transport packet into an internal RAM (FIG. 2). After the saving, the procedure advances to a PID determination 1, which comes next.

PID Determination 1 Processing:

This processing determines whether the TS header's PID (Packet descriptor) is the PAT (Program Association Table), the PMT (Program Map Table), the CAS (Conditional Access Table), or the NIT (Network Information Table). If YES, then the procedure advances to TS parsing 1 processing. If NO, then the processing advances to PID determination 2 processing.

PID Determination 2 Processing:

This processing determines whether the TS header's PID is the PES (Packetized Elementary Stream) packet. If YES, then this processing is skipped and the procedure advances to TS readout processing. If NO, then the procedure advances to PID determination 3 processing.

PID Determination 3 Processing:

This processing determines whether the TS header's PID is the DSM-CC section. If NO, then this processing is skipped and the procedure advances to TS readout processing. If YES, then the procedure advances to TS Parsing 2 processing.

TS Parsing 1 Processing:

This processing uses a standard method determined in ISO/IEC and ARIB to extract the PAT, PMT, CAS and NIT, and then the procedure advances to the TS readout processing. Note that, in the case where this line is taken, the TS is not eliminated or modified in the DSM-CC data carousel redundancy elimination processing.

TS Parsing 2 Processing:

This method uses a standard method determined in ISO/IEC and ARIB to extract the DSM-CC section from the transport packet, and then the procedure advances to the DSM-CC section determination 1 processing, which comes next.

DSM-CC Section Determination 1 Processing:

This processing determines whether the information in the DSM-CC section is the DII, based on the table_Id in the DSM-CC section. If NO, then the procedure advances to DSM-CC section determination2 processing. If YES, then the procedure advances to the DSM-CC section parsing processing, which comes next.

DSM-CC Section Determination 2 Processing:

This processing determines whether the information in the DSM-CC section is the DDB, based on the table_id in the DSM-CC section. If NO, then the procedure advances to PCR presence/absence determination processing. If YES, then the procedure advances to the usage prohibition flag determination processing.

DSM-CC Section Parsing Processing:

This processing uses a standard method determined in ISO/IEC and ARIB to parse the DSM-CC section and extract the DII. Then, the procedure advances to DII differential determination processing.

DII Differential Determination Processing:

This processing compares the DII previously saved in the internal RAM and the current DII for judgment. More specifically, the DII transaction_id is used to compare the extracted DII and the DII saved in the internal RAM, to determine whether there is a difference between the versions of the DII. If there is no differential (NO), then the procedure advances to processing for setting a usage prohibition flag to ON. If there is a differential (YES), then the procedure advances to the DSM-CC section saving processing 1, which comes next.

DSM-CC Section Saving Processing 1:

This processing saves the DSM-CC section containing the DII into the internal RAM, and then the procedure advances to processing for setting the usage prohibition flag to OFF.

DSM-CC Section Saving Processing 2:

This processing saves the DSM-CC section containing the DDB into the internal RAM, and then the procedure advances to processing for saving DownloadDataBlock.

Processing for Setting Usage Prohibition Flag to OFF:

This processing sets a usage prohibition flag, which is an internal variable (program variable), to OFF, and then the procedure advances to DownloadInfoIndication saving processing, which comes next.

Processing for Setting Usage Prohibition Flag to ON:

This processing sets a usage prohibition flag, which is an internal variable, to ON, and then the procedure advances to carousel skip descriptor generation processing, which comes next.

DownloadInforIndication Saving Processing:

This processing saves DownloadInfoIndication information into the internal RAM. Then, the procedure advances to the TS readout processing. Note that, in the case where this line is taken, the TS is not eliminated or modified in the DSM-CC data carousel redundancy elimination processing.

DownloadDataBlockSavingProcessing:

This processing saves DownloadDataBlock information into the internal RAM. Then, the procedure advances to the TS readout processing. Note that, in the case where this line is taken, the TS is not eliminated or modified in the DSM-CC data carousel redundancy elimination processing.

TS Readout Processing:

This processing reads out the transport packet saved in the internal RAM in the TS saving processing described above. Then, the procedure advances to the TS writing processing.

TS Writing Processing:

This processing writes the transport packet (1 TS-worth of data) into the post-processing TS buffer 14. The procedure then returns to the pre-processing TS buffer determination processing.

Carousel Skip Descriptor Generation Processing:

This processing generates the carousel skip descriptors (see FIG. 11), and then the procedure advances to private section generation carousel skip descriptor burying processing, which comes next.

Private Section Generation Carousel Skip Descriptor Burying Processing:

This processing generates the private section containing the carousel skip descriptors (see FIG. 13), and then the processing advances to the TS generation processing.

TS Generation Processing:

This processing generates the transport packet containing the private section, and then the processing advances to TS writing processing, which comes next (see FIG. 16).

Stuffing Descriptor Generation Processing:

This processing generates the stuffing descriptors (see FIG. 12), and then the procedure advances to private section generation stuffing descriptors burying processing.

Private Section Generation Stuffing Descriptors Burying Processing:

This processing generates the private section containing the stuffing descriptors (see FIG. 14), and then the procedure advances to TS replication/PID rewriting processing, which comes next.

TS Replication/PID Rewriting Processing:

This processing copies the transport packet header from the internal RAM and rewrites the PID from the DSM-CC section to the private section. The stuffing descriptors just generated are then written into the transport packet's payload, and then the procedure advances to the TS writing processing.

In other words, only the header portion of the transport packet stored in the TS saving processing is replicated, and the PID is rewritten with the private section containing the stuffing descriptors. The private section containing the stuffing descriptors is buried into the payload, and the transport packet containing the private section shown in FIG. 16 is generated.

PCR Presence/Absence Determination Processing:

This processing determines whether the adaptation field's PCR is present in the header of the transport packet saved in the internal RAM. If it is not present (NO), then the TS writing processing is omitted and the procedure returns to the pre-processing TS buffer determination processing. If it is present (YES), then the procedure advances to the carousel skip descriptors generation processing.

Usage Prohibition Flag Determination:

This processing makes a determination about the usage prohibition flag, which is an internal variable. If the flag is OFF (YES), then the procedure advances to DSM-CC section saving processing 2. If it is ON (NO), then the procedure advances to PCR presence/absence determination processing.

MISC Processing:

This processing is performed in the case where the result of the determination performed in the pre-processing TS buffer determination processing is NO. For example, in a case where the digital broadcast material transmitter has both the transmission side and the reception side and achieves both the functions, the DSM-CC data carousel restoration (reconstruction) processing described below can be also performed in this MISC processing.

[DSM-CC Data Carousel Restoration (Reconstruction) Processing]

FIG. 24 shows a flowchart of DSM-CC data carousel restoration (reconstruction) processing at the reception-side digital broadcast material transmitter (transmission-side device) 4, which is shown in FIG. 1 and FIG. 2.

This processing is software (program) processing performed by a CPU in the reception-side device 4 shown in FIG. 2. According to this processing, the transmission-side device 4 restores (reconstructs) the portions which are in the 2^{nd} and subsequent cycles and are the same version numbers as the DSM-CC section containing the DII (DownloadInfoIndication) and as DSM-CC section containing DDB (DownloadDataBlock) from the private section P containing the carousel skip descriptor(s) shown in FIG. 8 and FIG. 10.

The CPU performs the DSM-CC data carousel restoration processing according to the following sequence.

Initialization Processing:

In this processing, a 27 MHz self-running counter (FIG. 25) which is described below is reset. After that, the 27 MHz self-running counter's output data is monitored, while load settings and reset processing are performed for a 27 MHz self-running counter with a load function (FIG. 26) which is described below. Accordingly, in the PCR fluctuation suppression section A and the PCR fluctuation suppression section B, fluctuation can be suppressed, with respect to the PCR final byte that may be present in the adaptation field of the header of the transport packet (sometimes referred to as transport packet or TS), from one Sync byte through the 11^{th} Sync byte from the first one, counting the first one.

Further, a valid data generation unit (including a Reed-Solomon encoding function) which is described below (FIG. 26) notifies whether the transport packet to be outputted is a 188-byte transport stream packet, or a transport stream packet that is in 204-byte units and is also Reed-Solomon encoded.

Pre-Processing TS Buffer Determination Processing:

This processing determines whether 1 TS-worth of valid data is present in the pre-processing TS buffer 13 shown in FIG. 2. Specifically, the number of valid data in the pre-processing TS buffer 13 is read out, and it is determined whether there is 1 TS worth of data. In the case where there is no such data (NO), the processing advances to carousel augmentation start flag determination processing, which comes next. In the case where such data is present (YES), the processing advances to TS extraction processing, which comes next.

TS Extraction Processing:

This processing extracts (reads out) the transport packet (1 TS-worth of data) from the pre-processing TS buffer 13. After the extraction, the procedure advances to TS saving processing, which comes next.

TS Saving Processing:

This processing saves the extracted transport packet into an internal RAM. After the saving, the procedure advances to a PID determination 1, which comes next.

PID Determination 1 Processing:

This processing determines whether the TS header's PID (Packet descriptor) is the PAT (Program Association Table), the PMT (Program Map Table), the CAS (Conditional Access Table) or the NIT (Network Information Table). If YES, then the procedure advances to TS parsing 1 processing. If NO, then the processing advances to PID determination 2 processing.

PID Determination 2 Processing:

This processing determines whether the TS header's PID is the PES (Packetized Elementary Stream) packet. If YES, then this processing is skipped and the procedure advances to TS readout processing. If NO, then the procedure advances to PID determination 3 processing.

PID Determination 3 Processing:

This processing determines whether the TS header's PID is the private section. If YES, then this processing advances to private section parsing processing. If NO, then the procedure advances to PID determination 4 processing.

PID Determination 4 Processing:

This processing determines whether the TS header's PID is the DSM-CC section. If YES, then this processing advances to TS parsing 2 processing. If NO, then the processing is skipped and the procedure advances to TS readout processing.

TS Parsing 1 Processing:

This processing uses a standard method determined in ISO/IEC and ARIB to extract the PAT, PMT, CAS, and NIT, and then the procedure advances to the TS readout processing. Note that, in the case where this line is taken, the TS is not eliminated or modified in the DSM-CC data carousel restoration processing.

TS Parsing 2 Processing:

This method uses a standard method determined in ISO/IEC and ARIB to extract the DSM-CC section from the transport packet, and then the procedure advances to the DSM-CC section determination 1 processing, which comes next.

DSM-CC Section Determination 1 Processing:

This processing determines whether the information in the DSM-CC section is the DII, based on the table_id in the DSM-CC section. If NO, then the procedure advances to DSM-CC section determination 2 processing. If YES, then the procedure advances to the DSM-CC section parsing processing, which comes next.

DSM-CC Section Determination 2 Processing:

This processing determines whether the information in the DSM-CC section is the DDB, based on the table_id in the DSM-CC section. If NO, then the processing is skipped and the procedure advances to TS readout processing. If YES, then the procedure advances to the DSM-CC section saving processing.

DSM-CC Section Parsing Processing:

This processing uses a standard method determined in ISO/IEC and ARIB, to parse the DSM-CC section and extract the DII. Then, the procedure advances to the DSM-CC section saving processing 1.

DSM-CC Section Saving Processing 1:

This processing saves the DSM-CC section containing the DII into the internal RAM, and then the procedure advances to processing for setting a carousel augmentation start flag to OFF.

DSM-CC Section Saving Processing 2:

This processing saves the DSM-CC section containing the DDB into the internal RAM, and then the procedure advances to processing for saving DownloadDataBlock.

Processing for Setting Carousel Augmentation Start Flag to OFF:

This processing sets a carousel augmentation start flag, which is an internal variable (program variable) to OFF, and then the procedure advances to DownloadInfoIndication saving processing, which comes next.

DownloadInfoIndication Saving Processing:

This processing saves the DownloadInfoIndication information into the internal RAM. Then, the processing advances to the TS readout processing. Note that, in the case where this line is taken, the TS is not eliminated or modified in the DSM-CC data carousel restoration processing.

DownloadDataBlock Saving Processing:

This processing saves the DownloadDataBlock information into the internal RAM. Then, the processing advances to the TS readout processing. Note that, in the case where this line is taken, the TS is not eliminated or modified in the DSM-CC data carousel restoration processing.

TS Readout Processing:

This processing reads out the transport packet saved in the internal RAM in the TS saving processing described above. Then, the procedure advances to the TS writing processing.

TS Writing Processing:

This processing writes the transport packet (1 TS-worth of data) into the post-processing TS buffer 14. After this processing, the procedure then returns to the pre-processing TS buffer determination processing.

Private Section Parsing Processing:

This processing extracts the private section from the transport packet. That is, the processing parses the private section, and extracts the carousel skip descriptors or the stuffing descriptors. Then the procedure advances to descriptor determination processing.

Descriptor Determination Processing:

This processing determines whether the descriptors are carousel skip descriptors. If YES, then the procedure advances to the processing for setting the carousel augmentation start flag to ON. If NO, then the procedure advances to DSM-CC section replication processing 2.

Processing for Setting Carousel Augmentation Start Flag to ON:

This processing sets a carousel augmentation start flag, which is an internal variable to ON, and then the procedure advances to DSM-CC section replication processing 1, which comes next.

DSM-CC Section Replication Processing 1:

This processing reads out, from the internal RAM, the DSM-CC section containing the DII saved in the DSM-CC section saving processing 1, and replicates this. Then the procedure advances to the TS generation processing.

TS Generation Processing:

This processing generates the transport packet containing the private section shown in FIG. 17 and FIG. 18, and then the processing advances to TS writing processing, which comes next. Carousel Augmentation Start Flag Determination Processing:

This processing determines the carousel augmentation start flag, which is the internal variable. If the flag is ON (YES), then the procedure advances to the DSM-CC section replication processing 2. If OFF (NO), then other processing is performed in the MISC processing, and after that, the pre-processing TS buffer determination processing is performed once again.

DSM-CC Section Replication Processing 2:

This processing reads out, from the internal RAM, the DSM-CC section containing the DDB saved by the DSM-CC section saving processing 1, and replicates this. Then the procedure advances to the TS replication/PID rewriting processing.

TS Replication/PID Rewriting Processing:

This processing copies the transport packet header from the internal RAM and rewrites the PID from the private section to the DSM-CC section. The DSM-CC section just generated is then written into the transport packet's payload, and then the procedure advances to the TS writing processing.

In other words, only the header portion of the transport packet stored in the TS saving processing is replicated, and the PID is rewritten with the DSM-CC section. The DSM-CC section is buried into the payload, and the transport packet containing the DSM-CC section shown in FIG. 21 is generated.

MISC Processing:

This processing is performed in the case where the result of the determination performed in the pre-processing TS buffer determination processing is NO. For example, in a case where the digital broadcast material transmitter shown in FIG. 1 has both the transmission side and the reception side and achieves both the functions, the DSM-CC data carousel redundancy elimination processing described above can also be performed in the MISC processing.

[Detailed Construction of TS Extraction Controller]

FIG. 25 shows a detailed construction of a TS extraction controller 12 in the digital broadcast material transmitters 3, 4 shown in FIG. 2.

FIG. 25 is a diagram explaining a configuration in which: in the PCR fluctuation suppression section A and the PCR fluctuation suppression section B, the TS extraction controller 12 is used to store the PCR's location within the MPEG-TS signal on the input-side DVB-ASI in order to suppress the fluctuation of the 11^{th} byte from the Sync byte (as counted including this Syncbyte) with respect to the PCR final byte that could be present in the adaptation field of the transport packet header. The TS extraction controller 12 is provided with a 27 MHz self-running counter 121, a valid TS quantity counter 122, a Sync byte comparator 123, and a valid data extractor 124 having a Reed-Solomon decoding function.

The Sync byte comparator 123 compares the 8-bit data inputted at 27 MHz from the 10B/8B converter 11, with the Sync byte (0x47). In a case where the comparison indicates that it is the same as the Sync byte, the Sync byte comparator 123 sends a reset signal as a control signal to the valid TS quantity counter 122.

More specifically, the Sync byte comparator 123 obtains the control signal and the 8-bit data signal from the former stage 10B/8B converter 11, and the 27 MHz clock signal from the former stage clock extraction unit 19. Only in a case where the control signal indicates validity, a comparison is made to determine whether the value of the 8-bit data signal is the Sync byte determined for the transport packet header according to ISO/IEC13818-1. If they are the same, then the control signal (reset signal) is sent to a reset terminal (RST) of the valid TS quantity counter 122 of the latter stage, and the counter value of the valid TS quantity counter 122 is reset. Note that, the 10B/8B converter 11 is a portion that provides both synchronization byte detection processing shown in FIG. 5, and 8B/10B decoding (10B/8B conversion) processing.

Based on the CPU control's 188/204 settings, the valid data extractor 124 knows whether the MPEG-TS on the input DVB-ASI is the 188-byte transport packet, or is the transport packet which is 204 bytes and is also encoded with Reed-Solomon encoding. In the case of the latter, the transport packet is converted into the former 108-byte transport packet by means of Reed-Solomon decoding processing logic. The valid data extractor 124 uses the 8-bit data signal and invalidity signal (control signal) inputted at 27 MHz from the 10B/8B converter 11, to extract the valid data and write it to the pre-processing TS buffer 13 of the latter stage. At this time, the validity term is learned from the validity/invalidity signal, and as a result, the clock signal is provided to the valid TS quantity counter 122, and a write permission signal (WRITE ENABLE signal) is provided to the pre-processing TS buffer 13 of the latter stage.

More specifically, the valid data extractor 124 obtains the control signal and the 8-bit data signal from the 10B/8B converter 11 of the former stage, and the clock signal from the clock extraction unit 19 of the former stage. Only in a case where the control signal indicates validity, the 8-bit data signal is passed through the data input terminal (DATA) of the pre-processing TS buffer 13, and the control signal is sent to the clock terminal (CLK) of the valid TS quantity counter 122 of the latter stage, and to the write permission terminal (WRITE ENABLE) of the pre-processing TS buffer 13 of the latter stage.

Next, the pre-processing TS buffer 13 obtains the clock signal from the clock extraction unit 19 in the former stage, and internally incorporates the value of the 8-bit data signal according to the timing of the control signal obtained from the valid data extractor 124. Here, the 8-bit data signal taken in by the pre-processing TS buffer 13 is read out by the CPU through the CPU bus shown in FIG. 2, and is used for software processing in various types of processing explained using FIG. 23 and FIG. 24.

The 27 MHz self-running counter 121 obtains the clock signal from the clock extraction unit 19 of the former stage and is caused to count the internal counter value count upward, and outputs the 32-bit data signal to the TS time stamp buffer 16 in the latter stage. Furthermore, for this 27 MHz self-running counter 121, the reset signal from the CPU bus can be written in, and the 32-bit data signal can be read out through the CPU bus. Together with the 27 MHz self-running counter with load function described below (FIG. 26), it is also used to perform phase adjustments and determine delay times vis-à-vis the self-running counter.

The valid TS quantity counter 122 receives input of the reset signal from the Sync byte comparator 123 and the clock signal from the valid data extractor 124. When the reset signal is inputted, it is a 4-bit counter which operates by loading data “0x05” via the CPU bus. When the valid TS quantity counter 122 is at its maximum, it outputs the write enable signal to the TS time stamp buffer 16 by means of a carry terminal (Carry).

The valid TS quantity counter 122 in the former stage uses the control signal to notify the TS time stamp buffer 16 about the timing of the position of the valid data from the areas within 11 bytes behind the Sync byte (as counted including this Sync byte). The TS time stamp buffer 16 which has thus been notified receives the 32-bit data signal from the 27 MHz self-running counter 121 in the former stage, and takes this inside, from the data input terminal (DATA). Here, the 32-bit data signal which serves as the TS time stamp taken into the TS time stamp buffer 16, is used by the DVB-ASI generation control unit 15, which is described below (FIG. 26).

[Detailed Construction of DVB-ASI Generation Control Unit]

FIG. 26 shows a detailed construction of a DVB-ASI generation control unit 15 in the digital broadcast material transmitters 3, 4 shown in FIG. 2.

FIG. 26 is a diagram for explaining a configuration in which: in the PCR fluctuation suppression section A and the PCR fluctuation suppression section B, the DVB-ASI generation control unit 15 is used to maintain the PCR's location constant with respect to the MPEG-TS signal on the input-side DVB-ASI based on the stored PCR's location information in order to suppress the fluctuation of the 11^{th} byte from the Sync byte (as counted including this Synch byte) with respect to the PCR final byte that could be present in the adaptation field of the transport packet.

The DVB-ASI generation control unit 15 is provided with a 27 MHz self-running counter 151 with a load function, a TS time stamp comparator 152, and a valid data generation unit 153 having a Reed-Solomon encoding function.

The 27 MHz self-running counter 151 with the loading function is a counter capable performing phase control vis-à-vis the 27 MHz self-running counter 121 in FIG. 25 by means of signals inputted into a load terminal (LOAD) and a reset terminal (RS) connected to the CPU bus. The clock signal from the self-running counter 151 to the clock terminal (CLK) is provided by means of the clock extraction unit 19 (FIG. 2, FIG. 25) in the first portion. Output (a 32-bit data signal) from a data output terminal (DATA) of the self-running counter 151 becomes one data input into a TS time stamp comparator 152 in the latter stage.

That is, the 27 MHz self-running counter 151 with a load function obtains the clock signal from the clock extraction unit 19 and is caused to count the internal counter value upward, and outputs the 32-bit data signal to the TS time stamp comparator 152 in the latter stage. Furthermore, for this self-running counter 151, the reset (reset signal) from the CPU bus and an initial value of the counter can be written in. Together with the 27 MHz self-running counter 121, it is also used to perform phase adjustments and determine delay times vis-à-vis the self-running counter.

A TS time stamp comparator 152 gives, in advance, a read enable signal, which is a control signal, to a readout enable terminal (READ ENABLE) of the TS time stamp buffer 16 in the former stage. One time stamp value (32-bit data signal) is read out from the TS time stamp buffer 16. This is constantly compared with the counter value (32-it data signal) obtained from the former stage 27 MHz self-running counter 151 with the loading function. A 188-byte continuous control signal is generated, starting when the timing matches. This control signal is given to the readout enable terminal of the former stage post-processing TS buffer 14 and to the 8B/10B converter in the latter stage, and this serves a role of causing the 8B/10B converter 17 to obtain the valid data from the post-processing TS buffer 14.

In other words, this TS time stamp comparator 152 gives the readout enable signal to the TS time stamp buffer 16, and obtains the time stamp from the data output terminal (DATA) of the TS time stamp buffer 16, and saves this therein.

The TS time stamp comparator 152 has a function which, at the time when this time stamp which is being held and the value inputted through the data output terminal (DATA) of the 27 MHz self-running counter 151 with the loading function become equal to each other, activates the readout enable signal for the post-processing TS buffer 14, and the control signal which is the usage signal for the 8B/10B converter 17, and passes the data (8-bit data signal) which was read out in 1 TS size portions continuously from the post-processing TS buffer 14 to send it through the valid data generator 153 into the 8B/10B converter 17.

When transmission of 1 TS-worth of data is finished, the readout enable signal from the post-processing TS buffer 14, and the usage signal for the 8B/10B converter 17, are inactivated, and the 8B/10B converter 17 is prompted to generate the stuffing data K28.5. Note that, this 8B/10B converter 17 is a portion having both the 8B/10B encoding (8B/10B conversion) processing shown in FIG. 5, and the synchronized byte generation (insertion) processing.

Based on the 188/204 setting of the CPU control, a valid data generator 153 having the Reed-Solomon encoding function knows whether the MPEG-TS signal on the output DVB-ASI is the 188-byte transport packet, or the 204k-byte transport packet that is also Reed-Solomon encoded. In the case of the latter, the signal is converted to the 204-byte transport packet, according to the Reed-Solomon encoding processing logic.

[Variations]

The processings according to the embodiment described above may be provided as a program that can be executed on a computer, a storage device such as a CD-ROM or a flexible disk, or via communications lines.

Furthermore, the various processings according to the embodiment can also be performed by combining a freely selected plurality thereof, or all of them.

1. A data broadcast material transmission method (1) for ground wave digital broadcasting, which enables simultaneous transmission of images, audio, and data materials as broadcast materials to multiple locations via a cable communications network provided by a communication provider, the method comprising:
on a transmission side corresponding to an entrance portion to the cable communications network, eliminating, from an MPEG stream containing data broadcast materials, carousel redundant information set due to repeated transmissions; and
on a receiving side corresponding to an exit portion from the cable communications network, restoring the carousel redundant information to the MPEG stream.

2. The data broadcast material transmission method according to claim 1, further comprising:
setting a carousel redundant information elimination status into a user's free usage area in the MPEG stream, and transmitting the carousel redundant information elimination status from the transmission side to the receiving side.

3. The digital broadcast material transmission method according to claim 2, wherein the carousel redundant information elimination status includes restoration timing and a restoration quantity.

4. The data broadcast material transmission method according to claim 2, wherein the user's free usage area in the MPEG stream is a private section.

5. The data broadcast material transmission method according to claim 2, further comprising:
eliminating, as the carousel redundant information targeted for elimination, portions which are in 2^{nd} and subsequent cycles and have same version numbers as a DSM-CC section containing DII (DownloadInfoIndication) and a DSM-CC section containing DDB (DownloadDataBlock), and replacing the carousel redundant information with private sections containing carousel skip descriptors having less information volume and indicating the carousel redundant information elimination status.

6. The data broadcast material transmission method according to claim 1, further comprising:
utilizing a time stamp in which a self-running counter counts upward based on a clock signal extracted from the MPEG stream on the input side, and constantly maintaining a program clock reference position of the post-processing MPEG stream on the output side at a predetermined interval of a fixed delay with respect to the MPEG stream on the input side.

7. A data broadcast material transmitter for ground wave digital broadcasting, which enables simultaneous transmission of images, audio, and data materials as broadcast materials to multiple locations via a cable communications network provided by a communication provider, the transmitter comprising:
on a transmission side corresponding to an entrance portion to the cable communications network, a unit eliminating, from an MPEG stream containing data broadcast materials, carousel redundant information set due to repeated transmissions; and
on a receiving side corresponding to an exit portion from the cable communications network, a unit restoring the carousel redundant information to the MPEG stream.

8. The data broadcast material transmitter according to claim 7, further comprising:
a unit setting a carousel redundant information elimination status into a user's free usage area in the MPEG stream, and transmitting the carousel redundant information elimination status from the transmission side to the receiving side.

9. The digital broadcast material transmitter according to claim 8, wherein the carousel redundant information elimination status includes restoration timing and a restoration quantity.

10. The data broadcast material transmitter according to claim 8, wherein the user's free usage area in the MPEG stream is a private section.

11. The data broadcast material transmitter according to claim 8, further comprising:
a unit eliminating, as the carousel redundant information targeted for elimination, portions which are in 2^{nd} and subsequent cycles and have same version numbers as a DSM-CC section containing DII (DownloadInfoIndication) and a DSM-CC section containing DDB (DownloadDataBlock), and replacing the carousel redundant information with private sections containing carousel skip descriptors having less information volume and indicating the carousel redundant information elimination status.

12. The data broadcast material transmitter according to claim 7, further comprising:
a unit utilizing a time stamp in which a self-running counter counts upward based on a clock signal extracted from the MPEG stream on the input side, and constantly maintaining a program clock reference position of the post-processing MPEG stream on the output side at a predetermined interval of a fixed delay with respect to the MPEG stream on the input side.
